(19) United States
(12) Patent Application Publication
(10) Pub. No.: US 2010/0218136 A1
(43) Pub. Date: Aug. 26, 2010

(54) Method and Apparatus for User-Interactive Financial Instrument Trading

(75) Inventor: Vitaly N. Tyulyaev, Ballwin, MO (US)

Correspondence Address: THOMPSON COBURN LLP, ONE US BANK PLAZA, SUITE 3500, ST LOUIS, MO, 63101, US

(73) Assignee: SCOTTRADE, INC., St. Louis, MO (US)

(21) Appl. No.: 12/773,572

(22) Filed: May 4, 2010

Related U.S. Application Data
(62) Division of application No. 10/845,053, filed on May 13, 2004.

(51) Int. Cl. G06F 3/048

(52) U.S. Cl. 715/781

(57) ABSTRACT

An improved interface for interacting with a user of financial instrument trading software is disclosed herein. The improvements include efficient user access to multiple accounts, the ability to quickly cancel open orders from an interface window, the display of real-time quote data within an order entry window, greater flexibility in viewing quote data within a quotes window and chart data within a chart window, the display of a high/low graph for a financial instrument in a quote window, improved visual highlighting techniques for notifying the user of significant data relating to a financial instrument, the ability to embed a chart from a chart window into a quote window, the ability to effectively link different user interface windows together such that a user action in one linked window will have an effect in another window linked thereto, and the ability to efficiently manage open orders within an open orders window.

### CROSS-REFERENCE TO AND PRIORITY CLAIM TO RELATED APPLICATION

This application is a divisional of pending U.S. application Ser. No. 10/845,053, filed May 13, 2004, published as U.S. Patent Application Publication 2005/0256797, the entire disclosure of which is incorporated herein by reference.

### FIELD OF THE INVENTION

The present invention relates to an improved user interface for automated on-line financial instrument trading.

### BACKGROUND OF THE INVENTION

In the present day, investors are discovering that computers and, in particular, computer networks such as the Internet, are a particularly useful tool for managing and tracking their financial investment portfolio. Whether it is an individual investor seeking to occasionally buy or sell stocks, bonds, or other financial instruments; a day trader conducting numerous such transactions each day; or a professional investor such as a licensed broker who manages the financial portfolios of numerous clients; access via a computer network to financial markets to conduct these transactions is now and increasingly more so in the future an important channel for execution of this business.

Thus, a need in the art has developed for a user interface for such investors to flexibly and efficiently manage and track their investment portfolios from a computer such as a network-connected PC or network-connected office workstation. Basic user interfaces for financial instrument trading applications are prevalent in the art to provide users with features such as order entry windows that allow the user to (1) specify a stock symbol for a stock to be bought, sold, or otherwise transacted, (2) specify the number of shares of the stock for the transaction, and (3) submit the transaction over a network to a remote order processing system. Another prominent feature in conventional trading interfaces is a quote window that allows the user to request and view real-time quote data for selected financial instruments.

However, as use of these user interfaces has expanded, a need has developed for improvements in the user-friendliness and flexibility they provide. Directed toward these dual purposes of flexibility and user-friendliness, the inventor herein has developed an improved user interface for financial instrument trading that provides a number of unique and inventive new features.

### SUMMARY OF THE INVENTION

Thus, disclosed herein are various novel features and implementations that improve the user flexibility, inter-operability, functionality, and/or usability of user interfaces for financial instrument recordal, display and trading software applications, typically available and accessible by a user over an electronic network, such as the Internet, and typically hosted by a financial services firm or its representative, or alternatively used as a stand alone software package. These novel features are not limited to those enumerated in this section, and instead include all novel features disclosed in the entirety of this specification.

According to one aspect of the present invention, disclosed herein is an improvement to conventional user interfaces for financial instrument trading applications wherein a user can simultaneously view his/her positions in multiple accounts, without requiring the user to separately log in for each account.

According to another aspect of the present invention, disclosed herein is an improvement to conventional user interfaces for financial instrument trading applications wherein a quick cancel button is included on an order entry window to allow the user to efficiently cancel open orders.

According to another aspect of the present invention, disclosed herein is an improvement to conventional user interfaces for financial instrument trading applications wherein an order entry window in which the user has entered a financial instrument identifier displays real-time quote data for that financial instrument. This real time quote data is preferably displayed on buttons selectable by the user, wherein user selection thereof is effective to automatically populate pertinent data fields of the order entry window with the displayed quote data.

According to another aspect of the present invention, disclosed herein is an improvement to conventional user interfaces for financial instrument trading applications wherein the user is provided with the ability to request and view quote data within a quote window for a financial instrument that is broken down by the exchange(s) on which that financial instrument is traded.

According to another aspect of the present invention, disclosed herein is an improvement to conventional user interfaces for financial instrument trading applications wherein the user is provided with the ability to request and view quote data within a quote window for the constituent component financial instruments of a financial instrument index such as the Dow Jones.

According to another aspect of the present invention, disclosed herein is an improvement to conventional user interfaces for financial instrument trading applications wherein a quote window includes, as quote data, a high/low graph for a financial instrument that indicates how the financial instrument is currently performing in real-time relative to its closing price for the previous trading day.

According to another aspect of the present invention, disclosed herein is an improvement to conventional user interfaces for financial instrument trading applications wherein a highs and lows window is configured to utilize visual highlighting to indicate, in real-time, when a significant event has occurred for a financial instrument quote data update. Further, the highs and lows window preferably provides a running history for financial instrument quotes as updates occur therefor in real-time.

According to yet another aspect of the present invention, disclosed herein is an improvement to conventional user interfaces for financial instrument trading applications wherein a quote window utilizes a flash and dim technique to identify financial instrument quote data for which an update has been received.

According to yet another aspect of the present invention, disclosed herein is an improvement to conventional user interfaces for financial instrument trading applications wherein user interface windows for which user-customizable templates are available include controls on a toolbar for quickly changing the template that is applied to the user interface window. Two preferred user interface windows for this feature include a quote window and a chart window.

According to yet another aspect of the present invention, disclosed herein is an improvement to conventional user interfaces for financial instrument trading applications wherein a field is included in a chart window for efficiently allowing the user to add or remove chart(s) from the chart window.

According to yet another aspect of the present invention, disclosed herein is an improvement to conventional user interfaces for financial instrument trading applications wherein the user is provided with the ability to embed a chart from a chart window into other user interface windows such as a quote window.

According to yet another aspect of the present invention, disclosed herein is an improvement to conventional user interfaces for financial instrument trading applications wherein the user is provided with the ability to link different user interface windows together such that a user action within one of the linked user interface windows will cause a responsive effect in a user interface window that is linked thereto. Through such linking, the user can efficiently ensure that the windows shown on the screen include data of interest without requiring unnecessary re-entry of data or issuing repetitive requests.

According to yet another aspect of the present invention, disclosed herein is an improvement to conventional user interfaces for financial instrument trading applications wherein the user is providing with efficient control over the management of the open orders listed in the open orders window.

These and other features and advantages of the present invention will be in part apparent and in part pointed out in the following description and referenced figures.

### BRIEF DESCRIPTION OF THE DRAWINGS

FIG. 1 is a block diagram overview of a system for on-line financial instrument trading;

FIG. 2(a) is a block diagram overview of a financial instrument trading application in accordance with a preferred embodiment of the present invention;

FIG. 2(b) is a screenshot illustrating a preferred main

FIG. 3(a) is a screenshot of multiple user interface windows open simultaneously within the main interface window for different accounts of the same user;

FIG. 3(b) illustrates how a preferred embodiment of the present invention can provide a user with access to multiple accounts;

FIG. 3(c) illustrates how another preferred embodiment of the present invention can provide a user with access to multiple accounts;

FIG. 4 is a screenshot depicting a “quick cancel” feature of a preferred embodiment of the present invention;

FIGS. 5(a)-(d) are screenshots depicting the real-time display of quote data in the order entry window;

FIG. 6(a) is a screenshot of a preferred quote window allowing the display of quote for a financial instrument by exchange;

FIG. 6(b) is a screenshot of a preferred quote window allowing the display of quote data for the individual components of a stock index;

FIG. 7 is a screenshot of a quote window that includes high/low graphs for the listed stocks;

FIGS. 8(a)-(b) are screenshots of a highs and lows window in accordance with a preferred embodiment of the present invention;

FIG. 9(a) is a screenshot depicting a “flash and dim” feature for the quote window of the preferred embodiment of the present invention;

FIG. 9(b) illustrates the flash and dim highlight;

FIG. 10 is a screenshot depicting how user-customized templates can be loaded into a quote window;

FIG. 11 is a screenshot depicting how user-customized templates can be loaded into a chart window;

FIG. 12 is a screenshot depicting how a user can add charts to a chart window;

FIGS. 13(a)-(f) are screenshots depicting how data from various windows can be embedded within other windows;

FIG. 14(a) depicts an overview of the user interface window linking aspect of the preferred embodiment of the present invention;

FIGS. 14(b)-(d) are screenshots illustrating the preferred linking control; and

FIG. 15 is a screenshot illustrating a preferred technique for user control over the open orders listed in the open orders window;

### DETAILED DESCRIPTION OF THE PREFERRED EMBODIMENTS

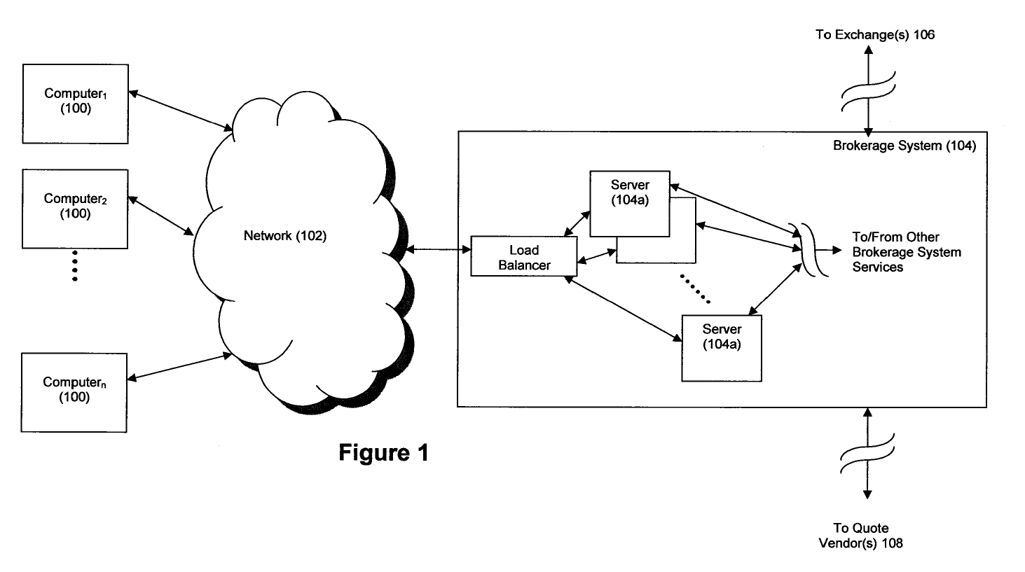

FIG. 1 illustrates the framework within which the preferred embodiment of the present invention resides. As shown in FIG. 1, one or more computers 100 are connected to a network 102 such as the Internet. However, it is worth noting that the network 102 can be any network providing data communications between remote computers, including but not limited to LANs, WANs, wireless networks, and the like. Further, while it is preferred that computer 100 be a desktop PC/workstation or laptop computer, it should be noted that the computer 100 can be any computing device capable of interacting with the user and network in the manner described herein. Particularly in view of the major advances that are constantly occurring in the computer arts, it should be noted that computers 100 could include devices such as PDAs and cell phones.

Through network 102, the computers 100 communicate with a brokerage system 104 to conduct transactions related to financial instruments. The term “financial instrument” is used in accordance with its ordinary meaning in the art to mean instruments that can be traded on a financial market or through an electronic order matching facility such as ECN, and includes, but is not limited to, items such as stocks, options, mutual funds, futures, securities futures, and the like. The term “financial instrument” does not include checks or money orders.

The brokerage system 104 operates to respond to requests for data from computers 100 and further operates to process transactions such as order activity requests from the computers 100. The brokerage system 104 basically acts as an accessible repository for the user's portfolio data and as an intermediary between the user and various exchanges 106 and quote data vendors 108. A preferred brokerage system 104 is the novel and unique one described in commonly owned and pending U.S. patent application Ser. No. 10/692,067 entitled “System and Method for the Automated Brokerage of Financial Instruments” filed Oct. 22, 2003, the entire disclosure of which is incorporated herein by reference. However, it should be noted that a wide variety of brokerage systems that can be used in the practice of the present invention are known in the art.

The user interactive trading application of the present invention is preferably embodied on a computer readable medium as a series of instructions, or code segments, executable by a computer's processing unit(s). These software instructions preferably reside in part on computer 100 (which can be referred to as the client computer or user computer) and in part on a server 104a of the brokerage system 104. Servers 104a, together with the brokerage system 104, act as a portal accessible by computers 100 over network 102 through which users conduct activity requests related to their accounts. In such an embodiment, the computer 100 preferably downloads, from a server 104a of the brokerage system 104, a client application which contains the code for each of the user interface windows and navigational logic for the trading application. Software instructions for interfacing the user interface windows with processing services of the brokerage system to pass appropriate data to the user interface windows and pass data for activity requests to the processing services of the brokerage system preferably reside on servers 104a of the broker system.

It should be noted that the software instructions for the trading application can also wholly reside on a server 104a of the brokerage system 104. In such a case, a client computer 100 can use a conventional web browser application to remotely access and run the trading application resident on servers 104a.

Examples of computer readable media upon which the trading application can be embodied include memory unit(s) of a computer or server, one or more compact disks (CDs), one or more floppy disks, or some combination thereof.

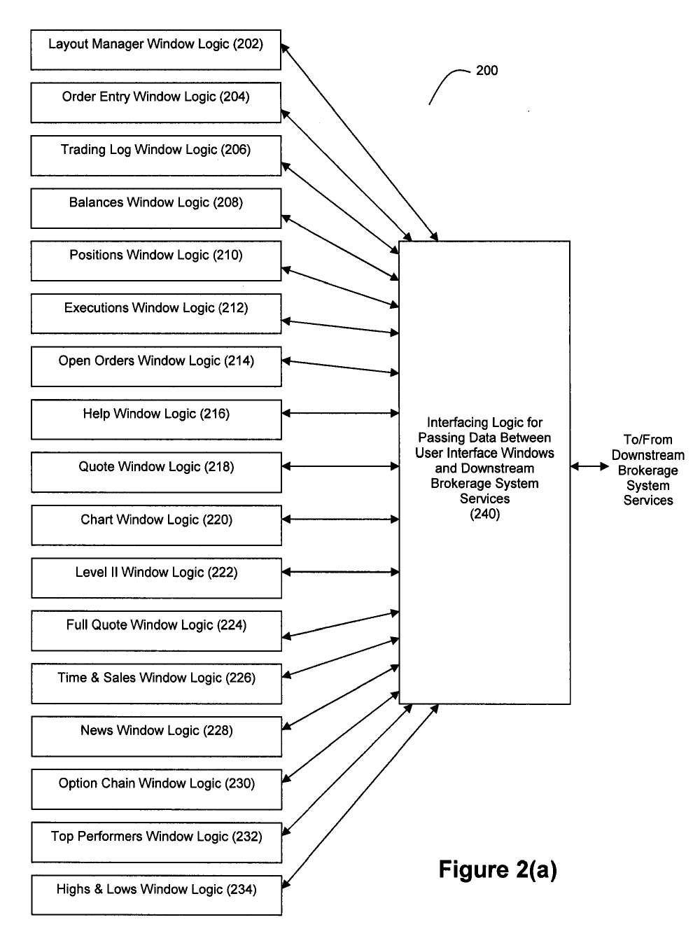

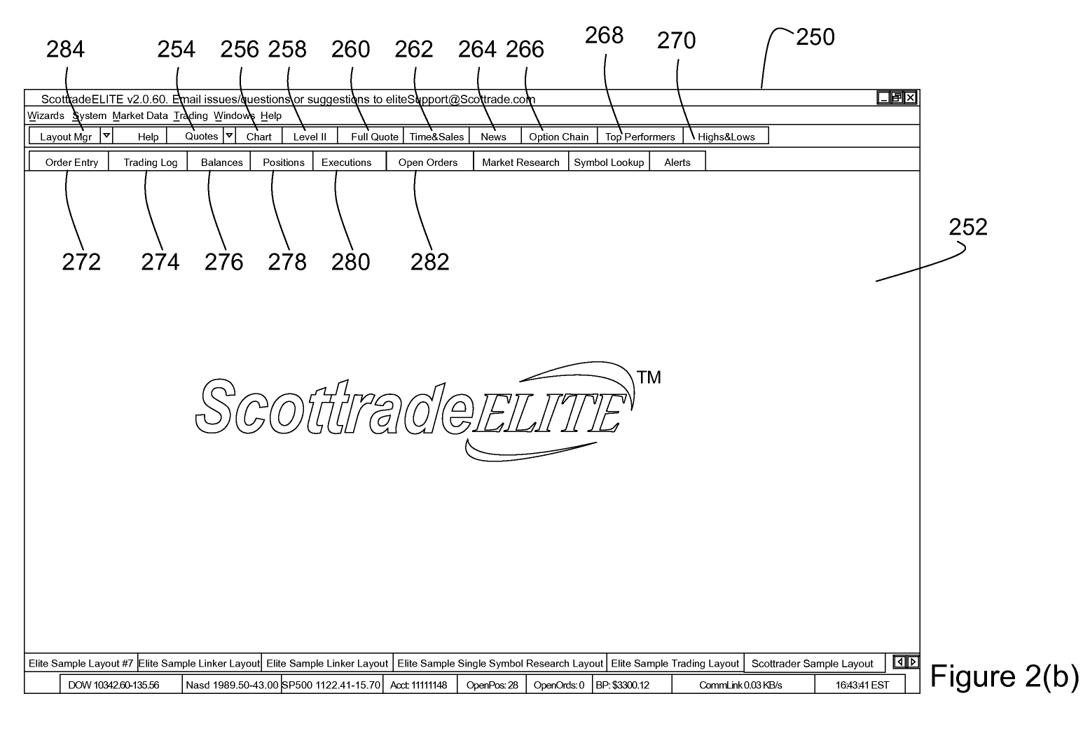

FIG. 2(a) is a block diagram illustrating a software overview 200 of the preferred embodiment of the present invention. Logic for various user interface windows are shown in blocks 202-234. These blocks correspond to the software code for displaying the various windows (e.g., the order entry window, the quote window, etc.), navigating among the windows, and interacting with the user. Each of these blocks 202-234 in turn communicates with interfacing logic block 240. Block 240 corresponds to software code for passing data between the various user interface window blocks 202-234 and downstream services of the brokerage system 104, such as order processing, obtaining quotes, obtaining account balance data, etc. The user interface windows of blocks 202-234 are preferably accessed from a main user interface window display.

FIG. 2(b) depicts a preferred main user interface window display 250. Buttons 254-282 are arranged in a toolbar of the main display 250 for selection by the user to create corresponding user interface windows in main display subportion area 252. For example, user selection of button 272 will cause an order entry window to appear in area 252. Similarly, user selection of button 256 will cause a chart window to appear in area 252. Area 252 is capable of simultaneously displaying a plurality of the user interface windows. Layout manager button 284 is selectable by the user to create a preferred layout of user interface windows in area 252 (e.g., an order entry window in the upper left corner of 252, a quote window below the order entry window, a highs and lows window below the quote window, a chart window in the upper right hand corner of 252, and a Level II window beneath the chart window). These preferred layouts can be saved and loaded upon demand by the user.

Because the basic elements of user interface windows for financial instrument trading software are well-known, including the program logic for their creation and the manner by which they can communicate data with a brokerage system 104 over a network 102, this technology will not be elaborated upon at length herein. However, to provide a frame of reference, some of the basics will be reiterated here.

To begin, a user typically starts the application. Preferably this is done by running the trading application program from computer 100 but can also include accessing the brokerage system 104 via a URL to run the program remotely or in a distributed manner. Thereafter, the user logs in to his/her account. This may be done either automatically by the computer or brokerage system upon start-up (such as by recognition of a cookie on the user's computer) or done manually through a user-entered ID and password as is known in the art.

Once logged in, the user can interact with the display 250 of FIG. 2(b) and issue a variety of activity requests to the remote brokerage system. The brokerage system then responds to the activity requests and provides return data for display on computer 100 where appropriate. Activity requests can be any action requested by a user that pertains to a capability of the system. Examples of activity requests include, but are not limited to, an order request to buy or sell a financial instrument, a modification request to modify an order to buy/sell a financial instrument, a request to view the portfolio for a given customer account, and a request to view recent trade history for a given customer account. These and other activity requests supported by the preferred embodiment will be apparent to a person of ordinary skill in the art upon a review of the specification herein.

Standard user interface windows for a trading application include an order entry window and a quote window. A conventional order entry window allows the user to issue an order-related activity request for a user-specified stock in a user-specified amount. A conventional quote window allows the user to view quote data in real-time for one or more user-specified stocks. Quote data, which is well-known in the art, includes, but is not limited to, data such as bid price, ask price, last price, and the like.

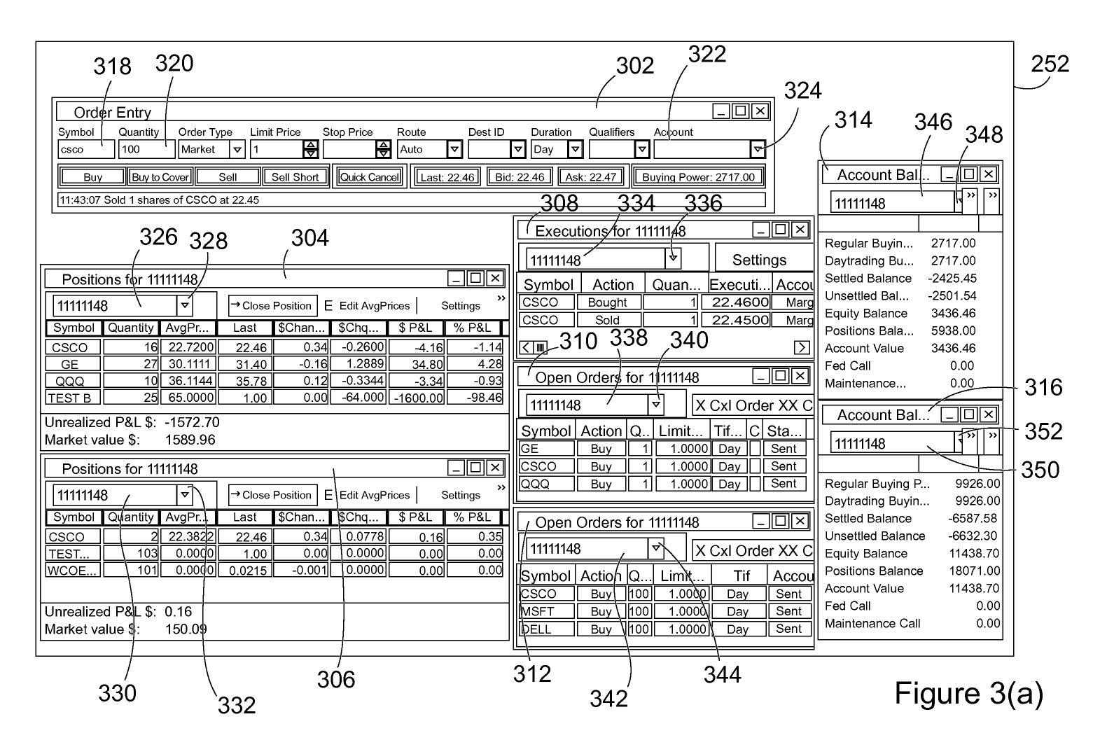

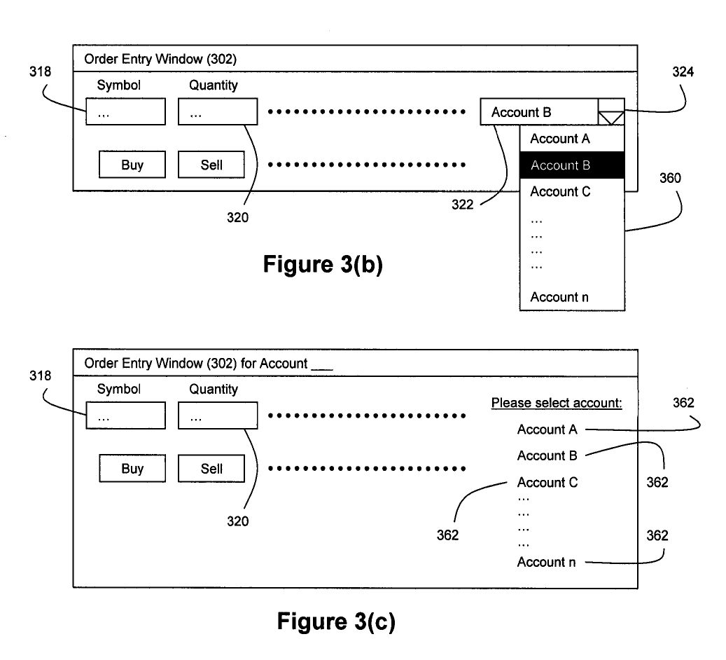

One unique aspect of the preferred embodiment of the present invention allows the user to simultaneously view his/her positions in multiple accounts, as shown in FIGS. 3(a)-(c). In conventional trading interfaces known to the inventor herein, a user who has multiple trading accounts must separately view each account. To improve the inefficiencies associated with conventional systems where a user wants to gain contemporaneous access to multiple accounts, the inventor herein has associated multiple accounts for the same user with the user's ID and password, so that upon logging in, the user has access to each account under his/her name. To associate multiple accounts possessed by the same user together, it is preferred that, offline, the user contact an administrator for the trading accounts and sign appropriate paperwork upon proof of identity to associate those accounts together. Upon completion of this paperwork, the user will be able to have contemporaneous access to multiple accounts at the same time.

In the example of FIG. 3(a), the computer 100 simultaneously displays multiple interface windows within area 252 of a single display 250. These windows may include, but are not limited to, one or more order entry windows 302 one or more positions windows 304 and 306, one or more execution windows 308, one or more open orders windows 310 and 312, and one or more account balance windows 314 and 316. The order entry window 302 preferably includes a field 318 for identifying the symbol of the financial instrument that is to be subject of an order, and a field 320 for the quantity of that order. The order entry window preferably includes other fields such as an order type (e.g., market, limit, stop, or stop limit), limit price, stop price, duration (day, good until canceled (GTC)), and others as is known in the art. Each positions window 304 and 306 preferably displays the positions held in the identified accounts. Each executions window 308 corresponds to a particular account held by the user and preferably displays the executions performed for the identified account. Each open orders window 310 and 312 corresponds to a different account held by the user and preferably displays the open orders listed in the identified accounts, and lastly, each account balance window 314 and 315 corresponds to a different account held by the user and preferably displays account data for the identified account(s), such as regular buying power, daytrading buying power, settled balance, unsettled balance, and the like.

Each window displayed in area 252 preferably identifies the account for which it displays data. Once the user logs in with his/her ID and password, the preferred embodiment of the present invention preferably provides access to each account associated with that ID and password through, for the order entry window example, field 322 and drop down menu control 324. FIG. 3(b) illustrates a preferred implementation of field 322 and control 324 in the context of the order entry window 302. Through drop down menu control 324, the user can view a menu 360 with a selectable listing of each account associated with the ID and password. Upon selection of an account from the list, the order entry window becomes attuned to that account such that any order entered through the window will be recorded against the account shown in field 322. Also, if a user is able to remember his/her account identifier, the user is preferably provided with the ability to directly enter that identifier into field 322 without use of the drop down menu control 324. Further still, rather than using a drop down menu 360 to be accessed through control 324, the window can alternatively configured to display a menu that lists selectable account links 362 without requiring the drop down control 324, as shown in FIG. 3(c).

Corresponding account control is provided in the other windows through (1) field 326 and control 328 for positions window 304, (2) field 330 and control 332 for positions window 306, (3) field 334 and control 336 for executions window 308, (4) field 338 and control 340 for open orders window 310, (5) field 342 and control 344 for open orders window 312, (6) field 346 and control 348 for account balance window 314, and (7) field 350 and control 352 for account balance window 316.

Accordingly, FIGS. 3(a)-(c) illustrate how a user can, after a single log in, simultaneously view multiple interface windows for multiple accounts within a single main display window 250. In conventional systems known to the inventor herein, users must either separately log in to gain contemporaneous access to multiple accounts or open multiple main displays 250. This feature of the preferred embodiment of the present invention eliminates those inefficiencies.

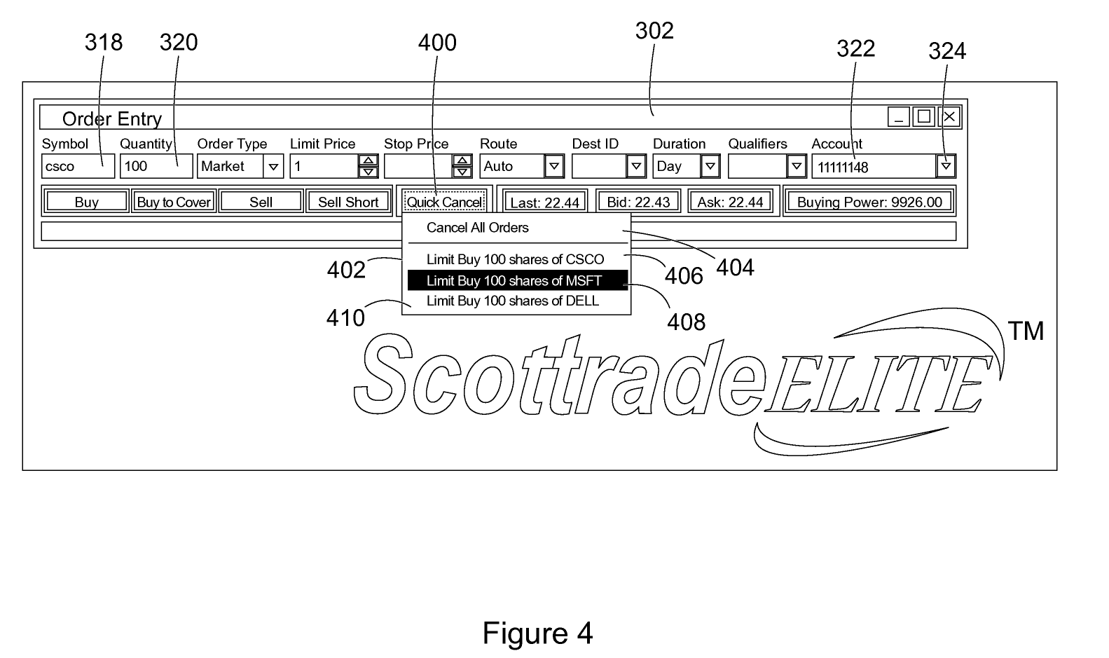

Another unique aspect of the preferred embodiment of the present invention allows the user to quickly cancel orders that have been placed but not yet executed, known as open orders, as shown in FIG. 4. To implement this feature, preferably, a “quick cancel” button 400 is added to the order entry window 302. The user's account (as indicated in field 322) will store data for that account's open orders. Upon user selection of button 400, a drop down menu 402 is preferably displayed that individually lists all open orders 406, 408, and 410 for the account. Each open order included on the list is preferably identified by data such as the type of order (e.g., a limit buy), the financial instrument that is the subject of the order (preferably identified by its symbol), and the quantity specified in the order. The drop down menu also preferably includes a user option to cancel all open orders 404. If the user selects one of the specific open orders 406, 408, or 410, that specific open order will be canceled to prevent execution thereof. If the user selects the “Cancel All Orders” option, all open orders for the account will be canceled to prevent execution thereof. It is worth noting that in the practice of this feature of the invention, drop down menu 402 that is activated upon user selection of button 400 can be replaced with a pop-up window having the same content and functionality.

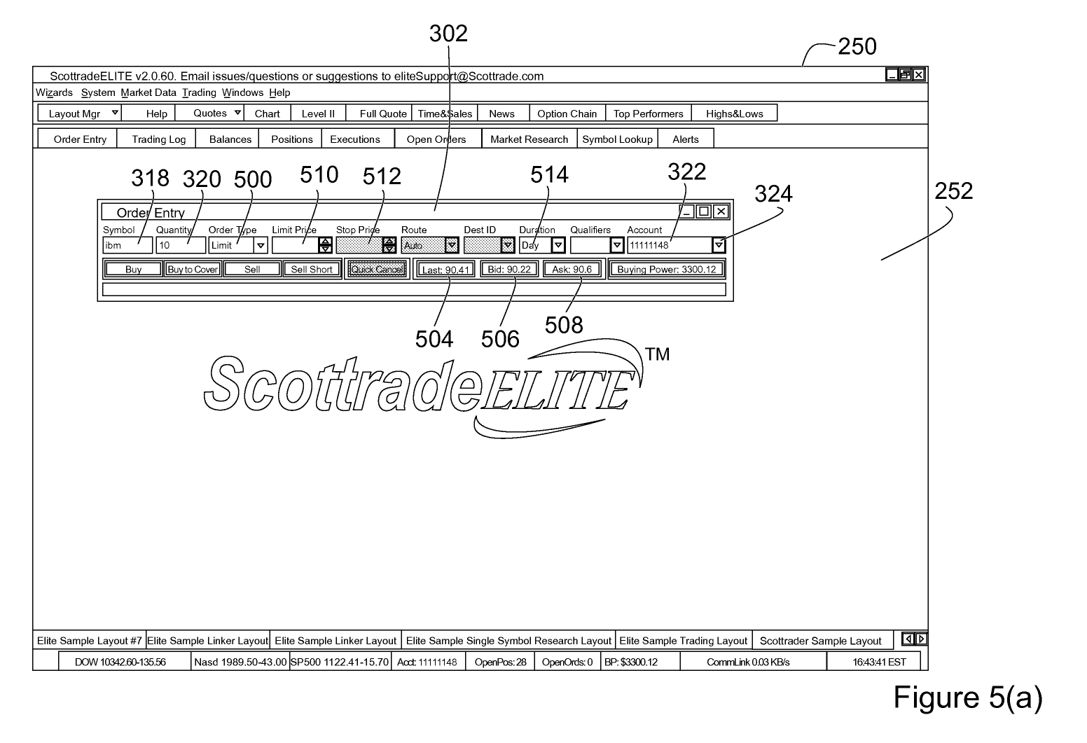

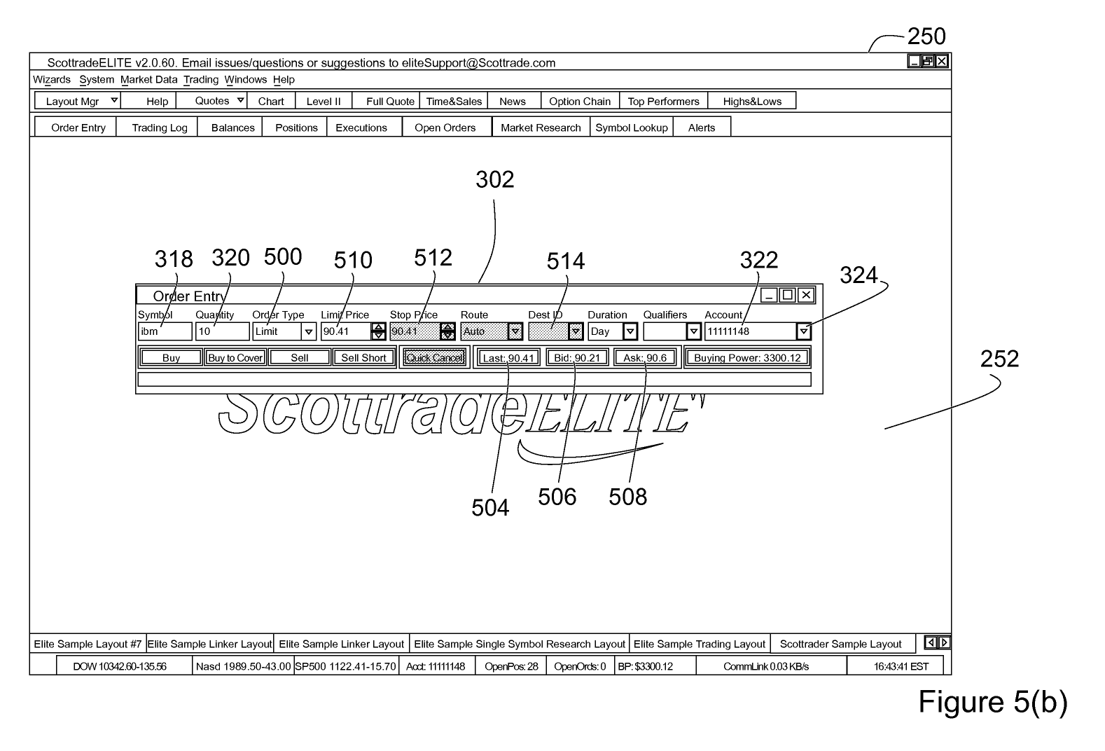

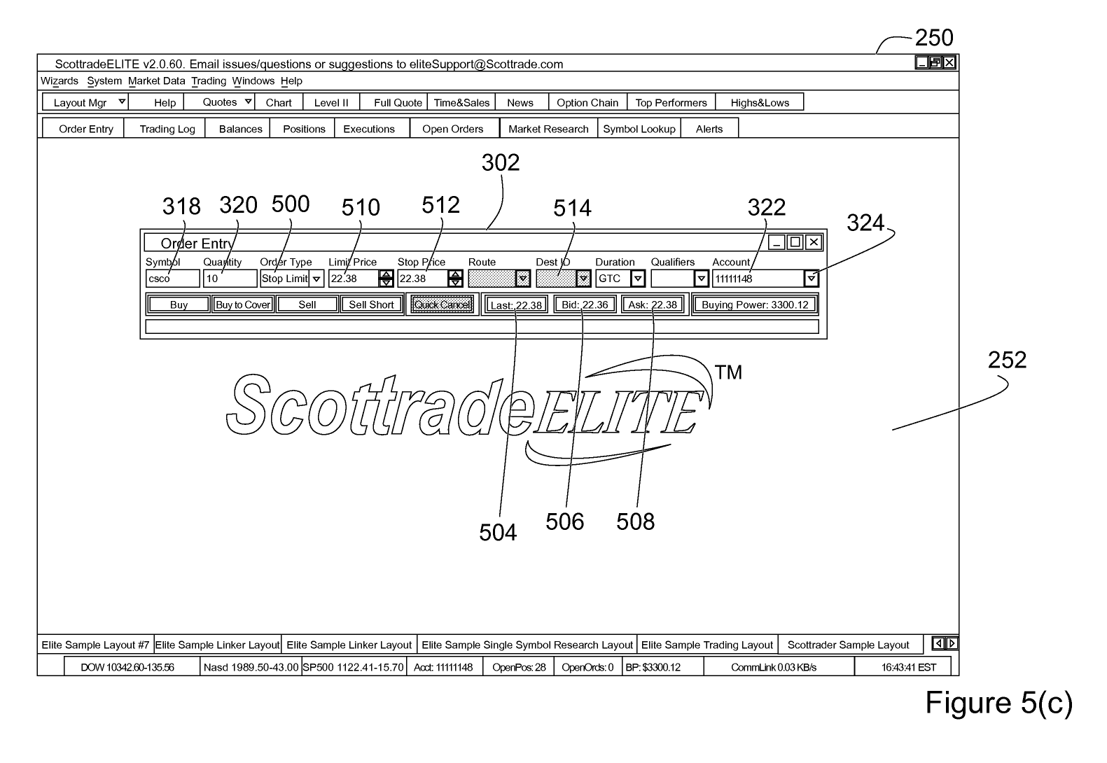

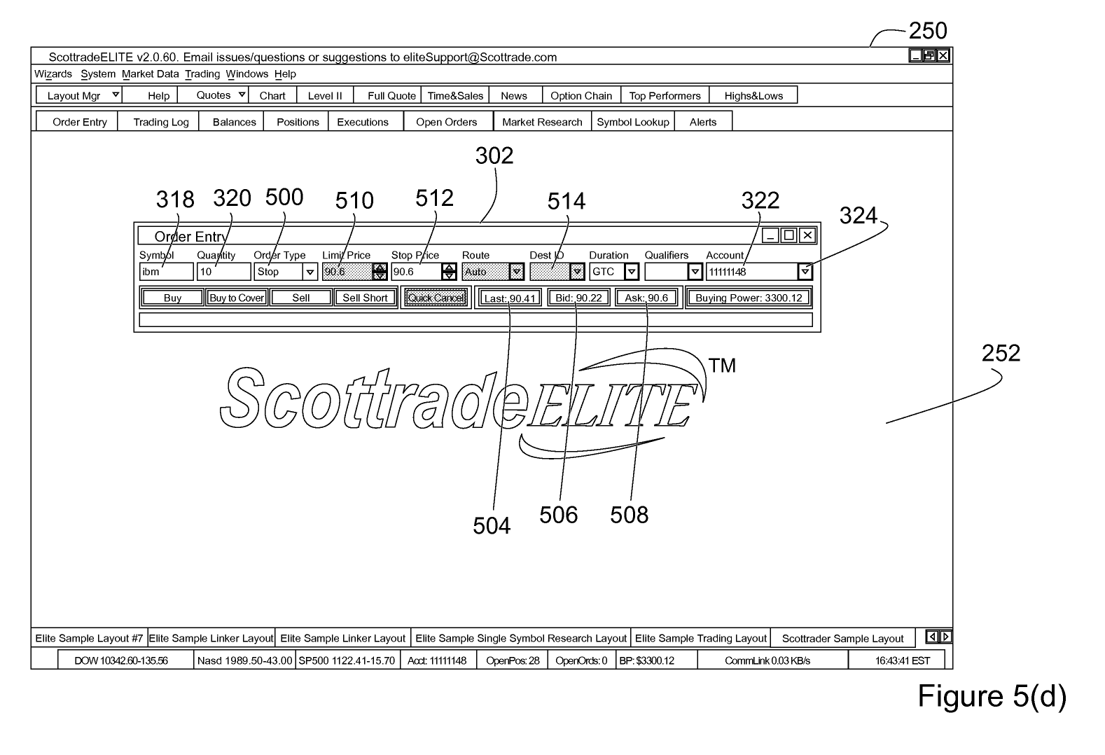

Another unique aspect of the preferred embodiment of the present invention relates to the inclusion in the order entry window 302 of a real-time display of quote data for the financial instrument specified by the user in field 318, as shown in FIGS. 5(a)-(d). In the order entry window of FIG. 5(a), buttons 504 (last price), 506 (bid price), and 508 (ask price) are included therein for this purpose. User selection of those buttons automatically populates the “limit price” field 510 and “stop price” field as appropriate depending upon order type (e.g., limit, stop, stop limit), as explained below. Last, bid, ask, limit, and stop prices are each well understood financial instrument trading terms. As different financial instrument identifiers are added to field 318 in the order entry window, the last, bid, ask displays 504, 506, and 508 are automatically updated with new quote data.

Last price button 504 provides the user with a real-time display from the order entry window of the current last price for the financial instrument of field 318. User selection of the last price button 504 is effective to automatically populate the “limit price” field 505 or the “limit price” field 510 and the “stop price” field 512 of the order entry window with the last price data displayed on button 504, thereby allowing the user to more quickly formulate an order. If the order type 500 for the order is “limit”, then preferably only “limit price” field 510 is actively populated, as shown in FIG. 5(b). If the order type 500 for the order is “stop”, then preferably only “stop price” field 512 is actively populated. If the order type 500 for the order is “stop limit”, then preferably both the “limit price” field 510 and the “stop price” field 512 are actively populated, as shown in FIG. 5(c).

Bid price button 506 provides the user with a real-time display from the order entry window of the current bid price for the financial instrument of field 318. User selection of the bid price button 504 is effective to automatically actively populate the “limit price” field 510 and the “stop price” field 512 of the order entry window with the bid price data displayed on button 506 depending upon the content of the order type field 500 as explained above.

Ask price button 508 provides the user with a real-time display from the order entry window of the current ask price for the financial instrument of field 318. Also, user selection of the ask price button 508 is effective to actively automatically populate the “limit price” field 510 and the “stop price” field 512 of the order entry window with the ask price data displayed on button 508 depending upon the content of the order type field 500. FIG. 5(d) depicts an example where the user selected the ask price button 508 for a stop order of 10 shares of IBM stock, to thereby automatically populate the active stop price field 512 with real time quote data for IBM's ask price.

By providing a real-time display of these pieces of quote data in the order entry window, the user is alleviated of the need to open a separate quote window to obtain this data, and further eliminates then need for the user to divide his/her attention between multiple windows to ruminate on whether he/she wishes to place, through the order entry window, an order activity request that is related to the financial instrument of field 318. Further still, through the automatic population effect of user selection of these buttons, users can more quickly formulate their orders.

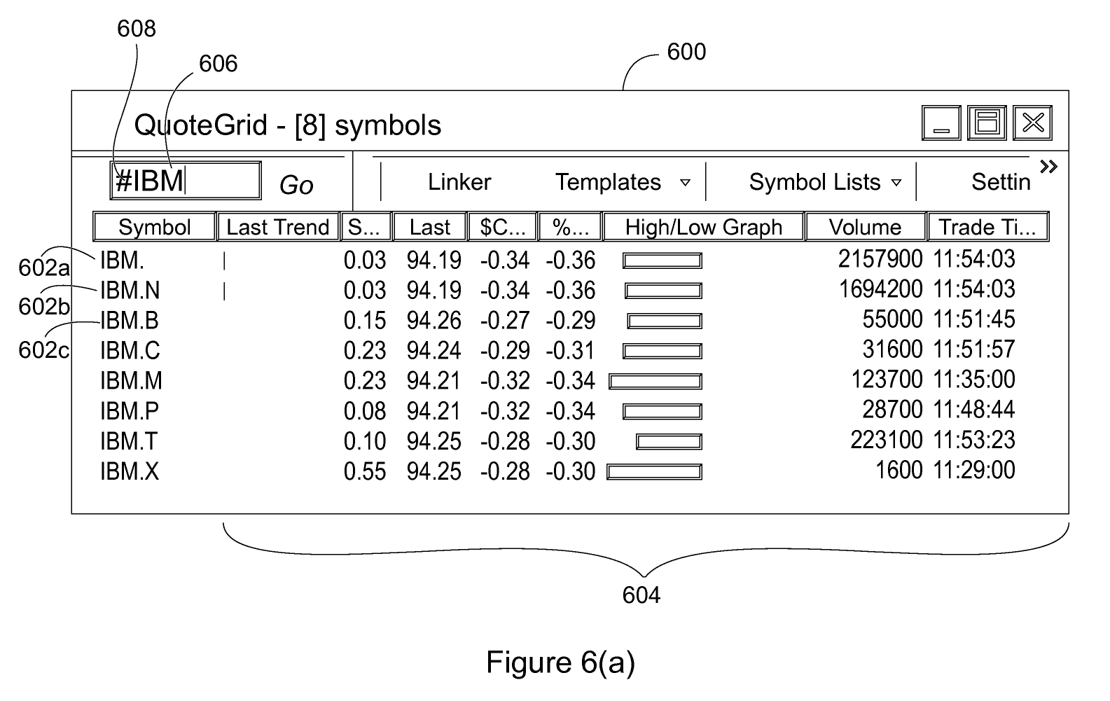

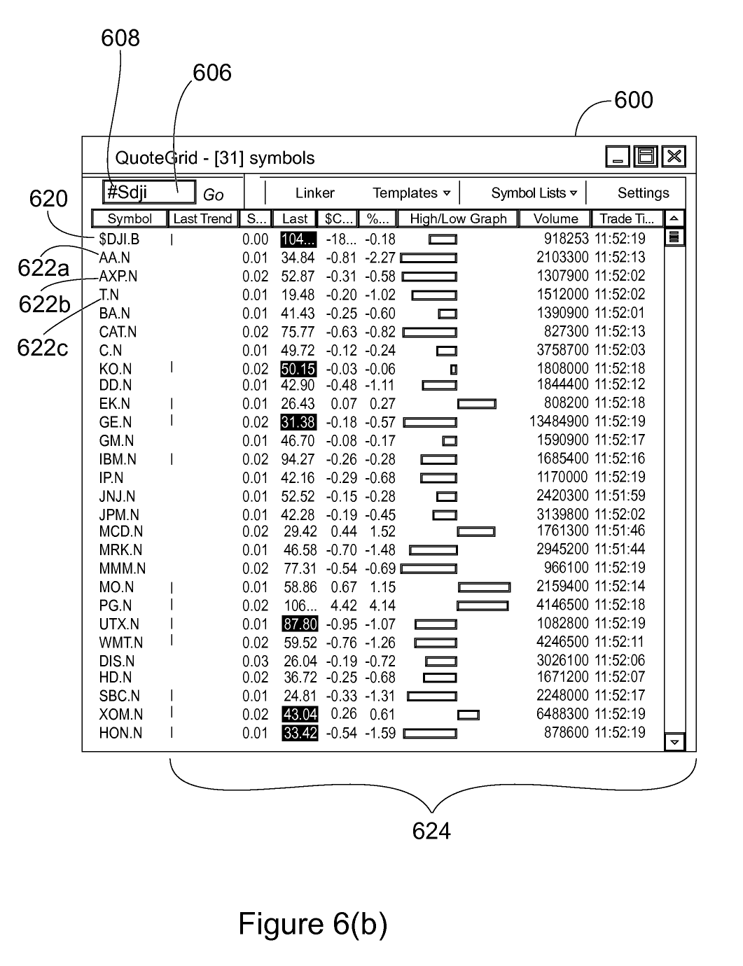

Another unique aspect of the preferred embodiment of the present invention relates to an improvement to the quote window wherein comprehensive quote data for a financial instrument can be provided upon user request. A preferred form of comprehensive quote data is quote data for a financial instrument that is broken down by the different exchanges on which the financial instrument is traded, as shown in FIG. 6(a). FIG. 6(a) depicts a quote window 600. Typical quote windows list each financial instrument in a row, with various types of quote data for that financial instrument listed by column. Quote window 600 includes a field 606 in which the user can specify the financial instrument for which real-time quote data is desired. For example, entry of the symbol for IBM stock in field 606 would be effective to display real-time quote data in columns 604 for IBM stock. According to this aspect of the preferred embodiment of the present invention, the user can append a tag 608 to the identifier specified in field 606 that is effective to cause the quote window to display quote data for the financial instrument that is broken down by the exchanges on which that financial instrument are traded. The tag serves as an identifier for the request to view quote data broken down by exchange. The preferred tag 608 for such “by exchange” quote data is the # symbol. However, it should be understood that symbols other than # can be used for this tag.

Each row 602a, 602b, 602c, . . . shown in quote window 600 corresponds to the financial instrument's quote data for a different exchange. The exchange is preferably identified by an identifier such as an extension appended to each symbol in each row. Preferred extensions include “.N” for the NYSE, “.B” for the Boston stock exchange, “.C” for the Cincinnati stock exchange, “.M” for the Midwest stock exchange, “.P” for the Pacific stock exchange, “.T” for the Third Market stock exchange, “.X” for the Philadelphia stock exchange, and others as needed. The extension “.” for the symbol listed in row 602a identifies the quote data for the composite stock, which is an aggregation of the quote data for that symbol on the different exchanges on which it is traded.

Another unique aspect of the preferred embodiment of the present invention relates to the user-specified display, in the quote window, of quote data for the individual financial instrument components of a stock index, as shown in FIG. 6(b). Often times, a user will be interested in viewing quote data for stock indices such as the Dow Jones Industrial Average. The Dow Jones Industrial Average is an industrial average computed from pricing for a number of constituent component stocks. Through the quote window of FIG. 6(b), the user can also view quote data for each of the component stocks of an index such as the Dow Jones. Using an identifier 606 for the index coupled with a tag 608 that is effective to expand the index to include a display of its components, the user can cause the display to include a row 620 with real-time quote data in columns 624 for the index specified in field 606 and rows 622a, 622b, 622c, . . . with real-time quote data in columns 624 for the constituent financial instrument components thereof. In a preferred embodiment, the expand tag that serves as an identifier for the request to view the constituent component data is the symbol #$. However, it should be understood that symbols other than #$ can be used for this tag.

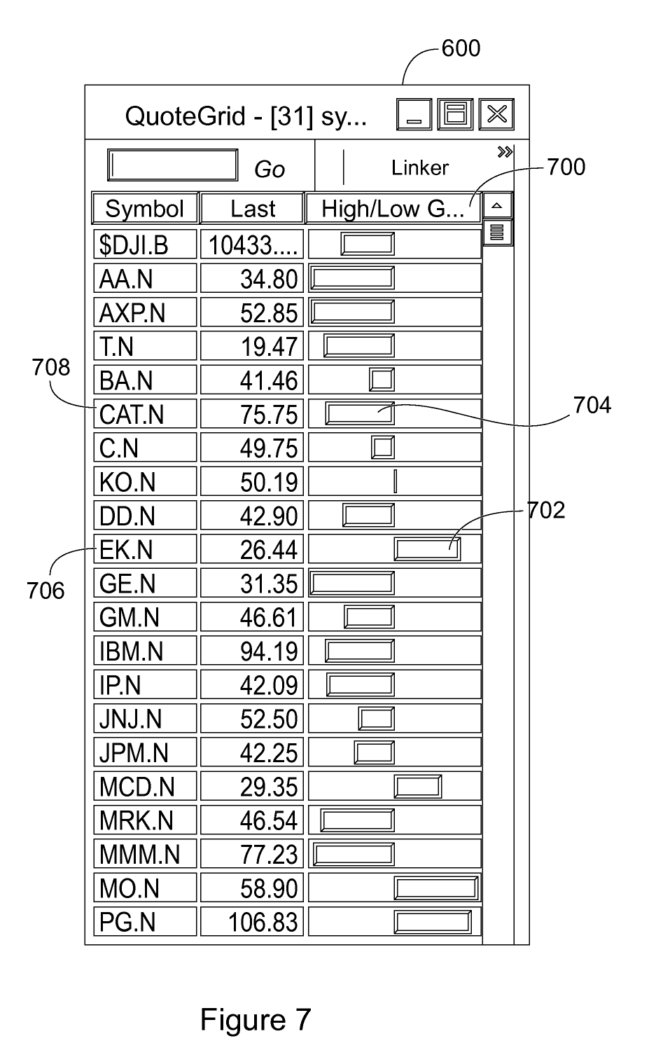

Another unique aspect of the preferred embodiment of the present invention relates to the display of high/low graphs in the quote window, as shown in FIG. 7. FIG. 7 depicts a quote window 600 in which the quote data includes a column 700 for a high/low graph corresponding to each listed financial instrument. The high/low graph is indicative of the degree to which a financial instrument's current price deviates from its price at the close of the previous trading day. The high/low graph and is preferably implemented as a horizontal bar graph. The center (or origin) of the graph corresponds to the price at which the financial instrument closed on the previous trading day. If the bar extends to the right, this is indicative that the current price for the financial instrument is greater than the previous trading day's closing price. If the bar extends to the left, this is indicative that the current price for the financial instrument is less than the previous trading day's closing price. The higher/lower the financial instrument's current price relative to its closing price for the previous day, the further to the right/left the bar will be in the graph. Further still, all of the high/low graphs in column 700 are preferably sized according to a common scale. In FIG. 7, the high/low graph 702 for the financial instrument of row 706 indicates that the current trading price for that financial instrument is much higher than it was the day before. Similarly, the high/low graph 704 for the financial instrument of row 708 indicates that the current trading price for that financial instrument is much lower than it was the day before. The high/low graphs of quote window 600 are preferably updated in real-time as changes occur.

It should be understood that the significance of a right direction and a left direction can be reversed depending upon the preference of a practitioner of the invention. Further still, it should be understood that the high/low bar graph can be a vertical bar graph wherein the up and down bars have opposite meanings that correspond to the right and left bars of the horizontal bar graph.

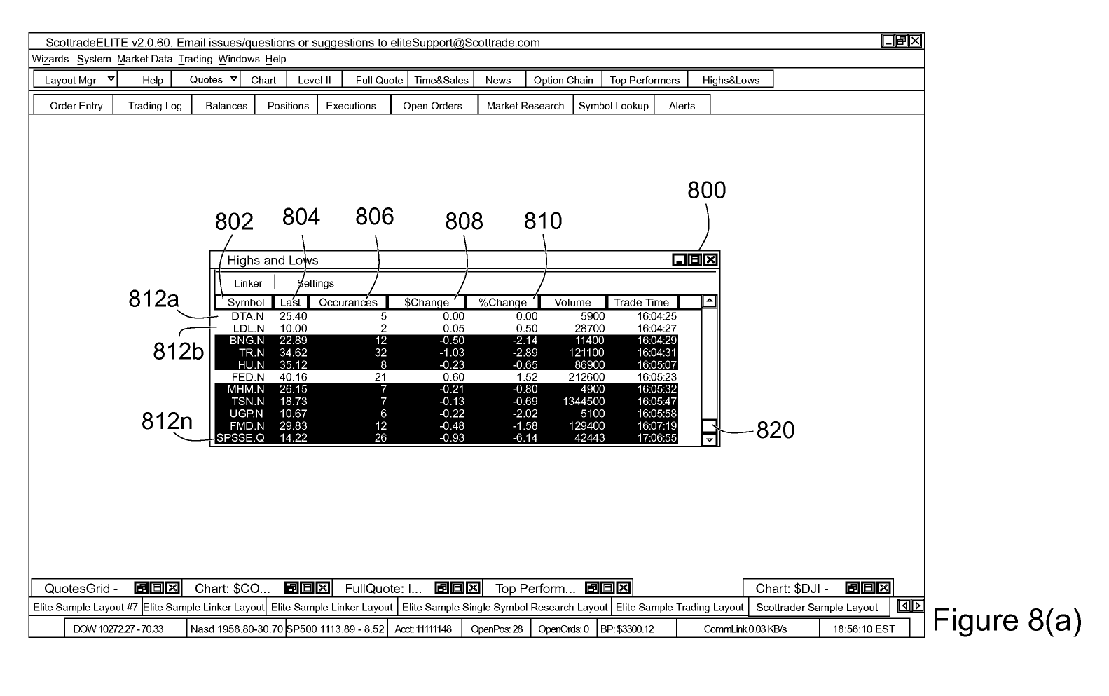

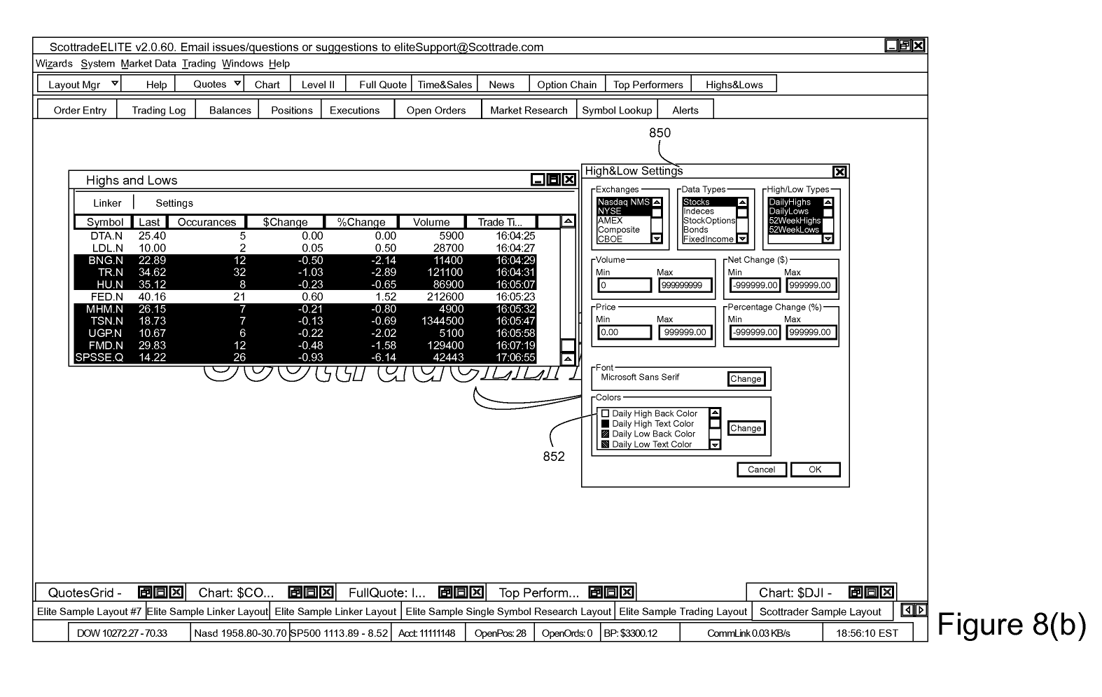

Another unique aspect of the preferred embodiment of the present invention relates to the display of high/low data in a highs and lows window, as shown in FIG. 8(a). The highs and lows window 800 includes various quote data for its listed financial instruments in rows 812a, 812b, . . . . Column 802 identifies the symbols for the listed financial instruments. Column 804 identifies the last price at which each financial instrument traded on the market. Column 806 identifies occurrences for the listed financial instruments, which tracks how many times that financial instrument hit the high or low for the day, thereby providing an indication of that financial instrument's momentum for the day. Column 808 identifies the amount of change in dollars for the current last price of the financial instrument relative to its closing price for the previous trading day. Column 810 identifies the percentage change for the current last price of the financial instrument relative to its closing price for the previous trading day.

The data of FIG. 8(a) is preferably continuously updated in real-time as new data is received. Also, to better convey meaningful data to the user, it is preferred that financial instruments for whose current last price data is at maximum thus far in the day and greater than the previous day's closing price be visually highlighted. Preferably, this visual highlight is implemented as a visual highlight of the row, or at least a subportion thereof such as the symbol identifier, for the financial instrument meeting this condition. Further still, for financial instruments whose current last price has broken its high for the year, a different manner of visual highlight is preferably used—preferably a visual highlight of the entire row for that financial instrument that is different in appearance than the visual highlight for the daily high. The same visual highlighting scheme can be used for financial instruments whose current last price is a daily/yearly low, albeit with different color coding. That is, color coding can be used for these scenarios for highs and lows, wherein one color is used as the visual highlight for daily/yearly highs and a different color is used as the visual highlight for daily/yearly lows. As a default, it is preferred that financial instrument highs for the day have the background of their rows, or at least a portion thereof, highlighted in green. Financial instrument lows for the day have the background of their rows, or at least a portion thereof, highlighted in red. Yearly highs have the whole row background highlighted in a third color, and yearly lows have the whole row background highlighted in a fourth color. Further still, it is preferred that the user be given the ability to modify the color coding scheme for the visual highlights from the default values, if so desired. As shown in FIG. 8(b), a window 850 is provided for this purpose. Through colors menu 852 of window 850, the user can individually specify the color coding for background and text for daily/yearly highs and lows.

As noted above, the highs and lows window 800 preferably provides a running history of the financial instruments listed therein. A new row 812n is added to the window each time that new data is received for a high or low. Preferably the new row is added as the bottommost row 812n, although this need not be the case as the new row could instead be added as the topmost row. Visual highlights and color coding are preferably implemented as described in the previous paragraph. The user preferably uses slider bar 820 to scroll through the older highs and lows data.

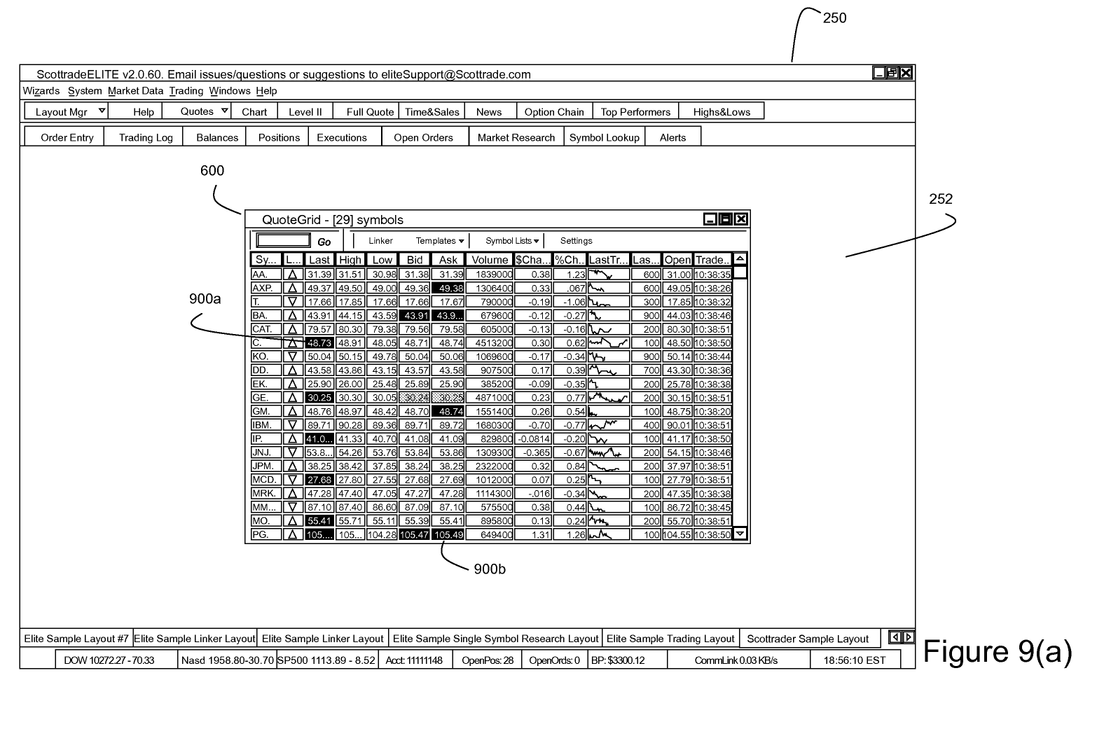

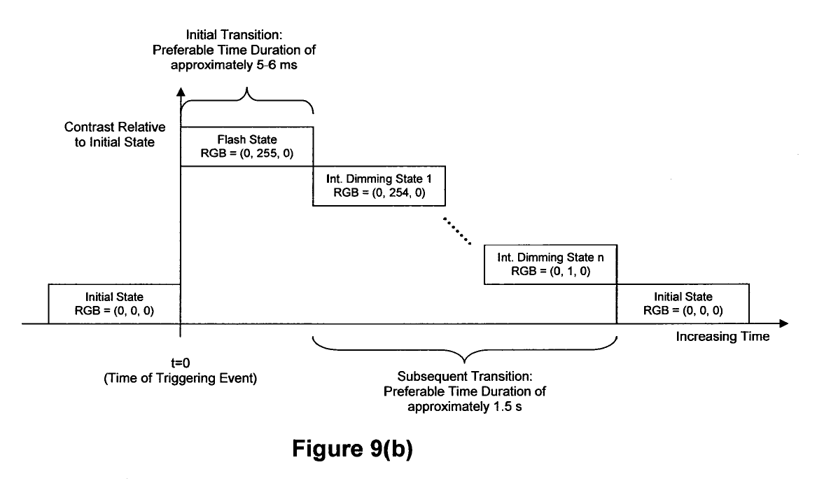

Another unique aspect of the preferred embodiment of the present invention relates to the display of quote data in the quote window such that quote data for which an update is received is visually highlighted for the user through a “flash and dim”, as shown in FIGS. 9(a) and (b). The quote window 600 of FIG. 9(a) includes various columns of quote data for each of the listed financial instruments. This quote data is preferably continuously updated in real-time. As an update is received that causes an item of quote data to change values, it is preferred that the quote window visually highlight the quote data item update through a “flash and dim” of the updated quote data item. In FIG. 9(a), quote data items 900a and 900b have received updates that caused a “flash and dim” to occur.

This “flash and dim” preferably comprises an initial transition for the updated quote data item from an initial normal state to a highlighted state followed by a subsequent transition from the highlighted state back to its initial normal state, wherein the initial transition occurs substantially more rapidly than the subsequent transition. During the subsequent transition, the highlight preferably progresses from a peak intensity back to the normal intensity through a plurality of successively lower intensity highlight states. FIG. 9(b) illustrates this process wherein, upon a triggering update at time t=0, the background of the updated quote data item quickly flashes to a flash state and thereafter transitions through at least one intermediate dimming state back to its initial state. In FIG. 9(b), the x axis represents time and the y axis represents the degree of contrast for the background relative to its initial state. This allows the user to perceive the updated data item without missing the update. By the time the user's eyes focus on the flash, the updated quote data item will be in a dimming state that the user can easily perceive. Without such a dim, in a system where the initial transition and subsequent transition are of substantially the same time length, the user, by the time his/her eyes adjust to the flash, may lose track of which quote data item flashed.

A preferred time duration for the flash state is 5-6 ms. A preferred time duration for the subsequent transition from the flash state back to the initial state is preferably around 1.5 s, however this duration will depend upon the color of the initial state relative to the flash state. It is preferred that every 5-6 ms during the subsequent transition, the RGB value of the background increment/decrement by one unit until the RGB value reaches its initial state. In an example where the initial state has an RGB value of (0,0,0) (black), and where the flash state is the peak green intensity of RGB=(0,255,0), the intermediate dimming states during the subsequent transition will progress from (0,255,0) to (0,254,0) at time t=Lₜ, to (0,253,0) at time t=(2)(Δₜ), to (0,252,0) at time t=(3)(Δₜ), and so on until the RGB state of the background returns to (0,0,0), where Δₜ is approximately 5-6 ms and is measured from a baseline of when the quote data item update occurred. Given that the user can preferably control the RGB value of the initial state and the flash state, the number of intermediate dimming states can vary.

Further, it is preferred that the flash and dim be color coded depending upon whether the updated value for the quote data item indicates an increasing price or a decreasing price. For example, a red highlight can be used for updates indicative of an increasing price and a green highlight can be used for updates indicative of a decreasing price.

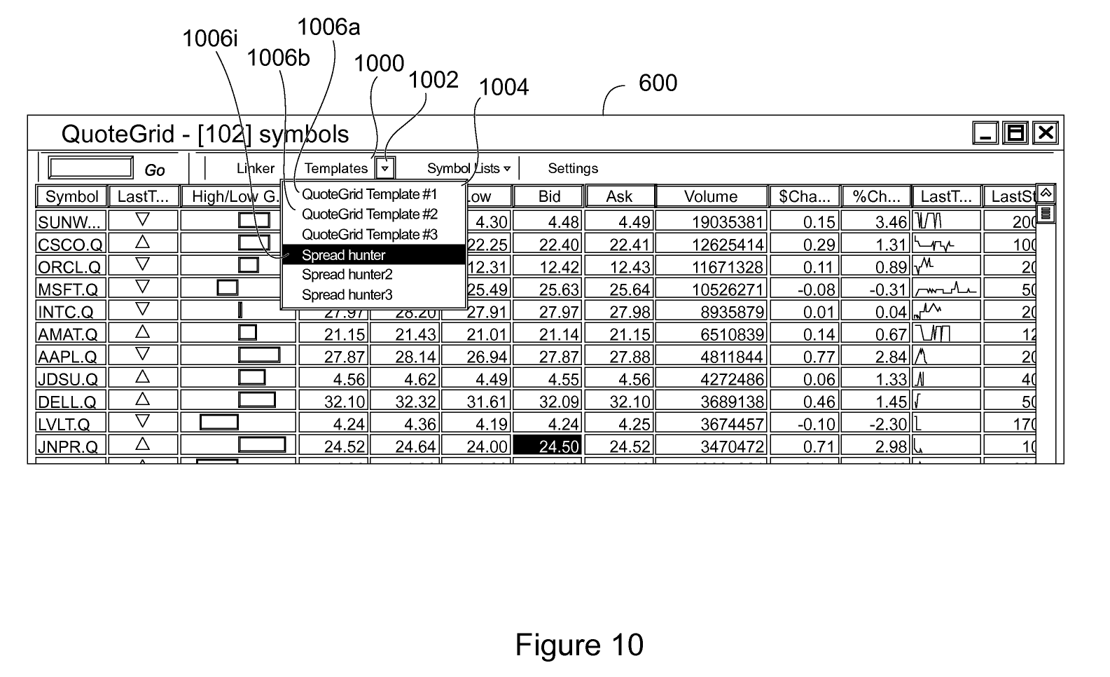

Another unique aspect of the preferred embodiment of the present invention relates to the importation into the quote window of customized templates of quote data, as shown in FIG. 10, without requiring the user to change the layout of windows in area 252 of display 250. The application preferably stores a plurality of customized quote window templates, each template defining the number of columns in the quote window, which types of quote data are displayed in the columns of the quote window, and the order of the columns in the quote window. Further, each template can be named by the user.

According to this feature of the preferred embodiment, the quote window 600 preferably includes a button 1000 thereon that is selectable by the user to choose which customized template is to be loaded into the quote window. Drop down menu control 1002 is preferably selectable by the user to call up drop down menu 1004 for display. Drop down menu 1004 lists each customized template 1006a, 10006b, . . . 1006i that is eligible for loading into the quote window 600. Upon user selection of the template to be loaded, the quote window is reconfigured on the fly for the listed financial instruments in accordance with the selected template. That is, the existing quote window transitions to the new template while retaining the same list of financial instruments as before. Also, if button 1000 is selected rather than drop down menu control 1002, a popup window is preferably displayed that is similar in content and functionality to menu 1004.

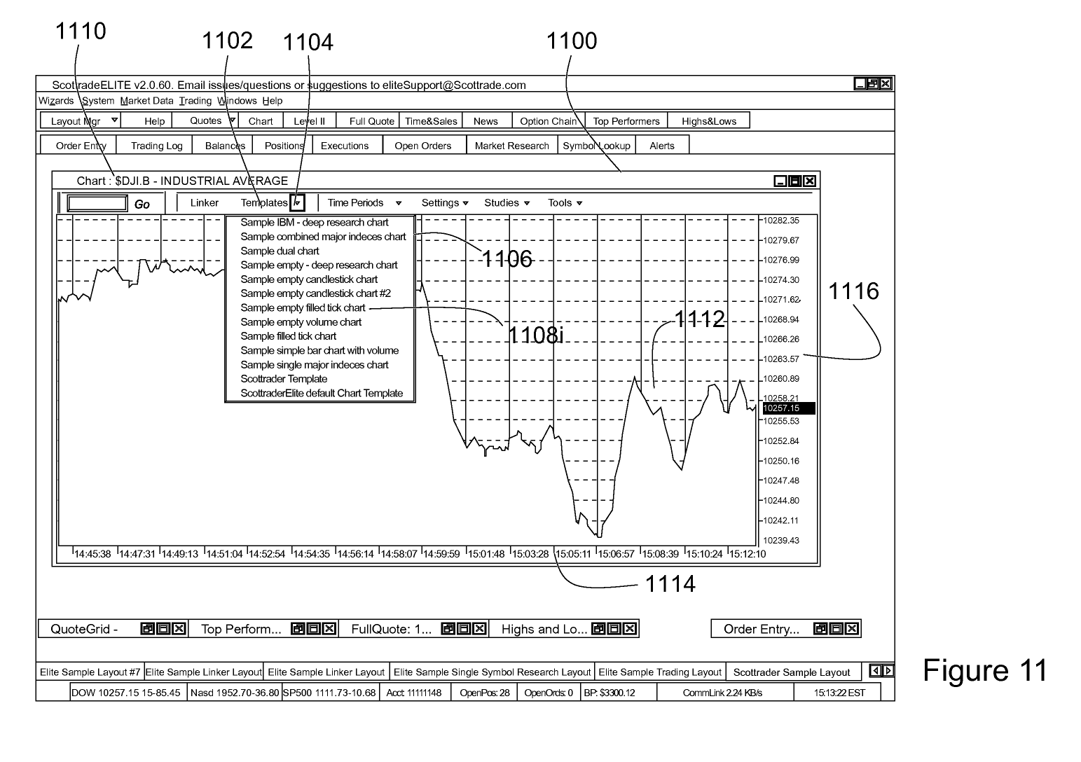

The same technique for loading customized quote window templates can be used for loading chart window templates. A chart window depicts a graphical measure for at least one financial instrument on an x-y scale wherein the x axis is typically time and wherein the y axis is typically a user-specified type of quote data. FIG. 11 depicts an example of a chart window 1100. The x axis of the chart corresponds to time, the y axis corresponds to price, and chart 1112 is the charted price for the listed symbol 1110, which in this case is the Dow Jones Industrial average. Through this feature of the preferred embodiment of the present invention, template button 1102 and drop down control 1104 can be used to load any of a number of pre-stored user-customized chart templates 1108i from drop down menu 1106 into the chart window 1100. The user can thus create a number of charts with various types of data along the x and y axes, and thereafter conveniently load these templates into the chart window through the template controls.

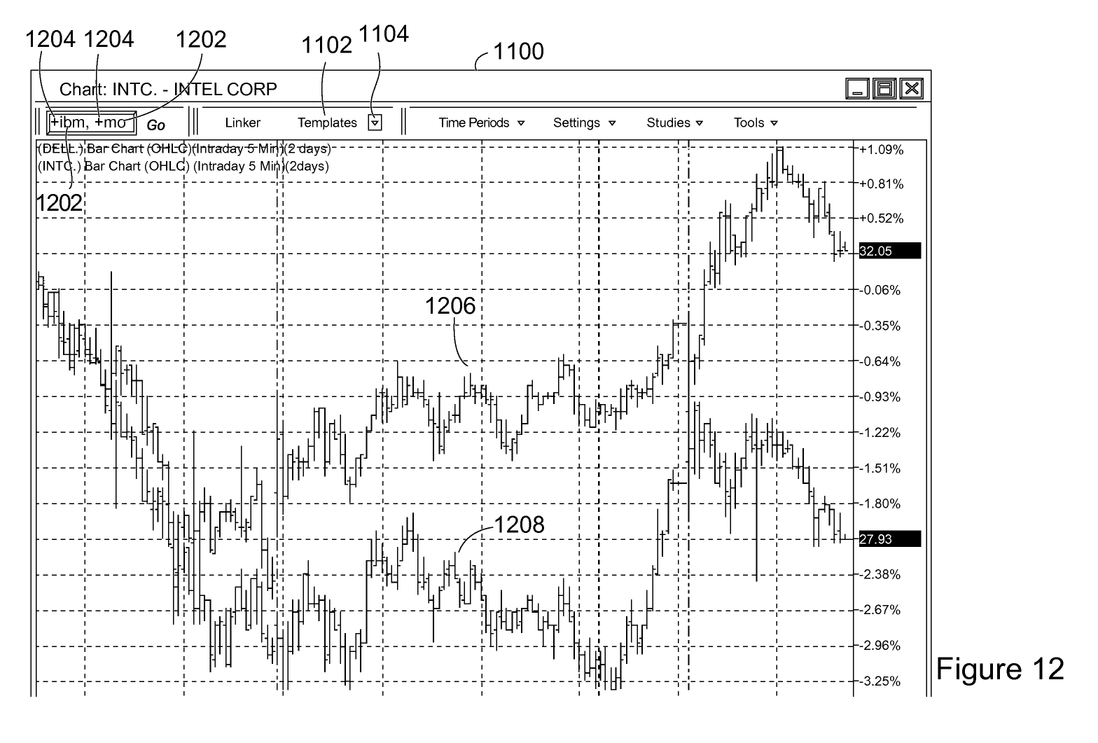

Another unique aspect of the preferred embodiment of the present invention relates to the ability of the user to easily add and/or remove charts to/from the chart window 1100 with modification instructions, as shown in FIG. 12. The chart window 1100 preferably includes a field 1200 through which the user can specify the financial instruments for which charted data is to be added to the chart window. By including a tag 1204 with an identifier 1202 for the financial instrument, the user can add a chart to the current chart window. The preferred identifier 1202 is the symbol for the financial instrument. The tag 1204 serves as an identifier for an add operation or a removal operation. The preferred tag 1204 for an add operation is a “+” character. The preferred tag for a removal operation is a “−” character. However, as should be readily understood, different tags and identifiers can be used in the practice of this aspect of the preferred embodiment of the present invention. Further, the user can add multiple charts to the window at once by sequentially entering identifiers 1202 and tags 1204 in field 1200. The chart window 1100 of FIG. 12 includes two charts 1206 and 1208. If the user enters “+ibm” and “+mo” in field 1200, new charted data for IBM stock and MO stock would be added to chart window 1100. Further still, if the user successfully added a chart for IBM stock to the chart window, the user can thereafter remove the IBM chart from the window by entering “−IBM” in field 1200. Moreover, it is worth noting that the user can enter a plurality of tag/identifier pairs in field 1200, where the tags need not match. Thus, for a chart window displaying an IBM chart, when the user enters “+MO, −IBM” into field 1200, the end result will be a chart window that includes an MO chart.

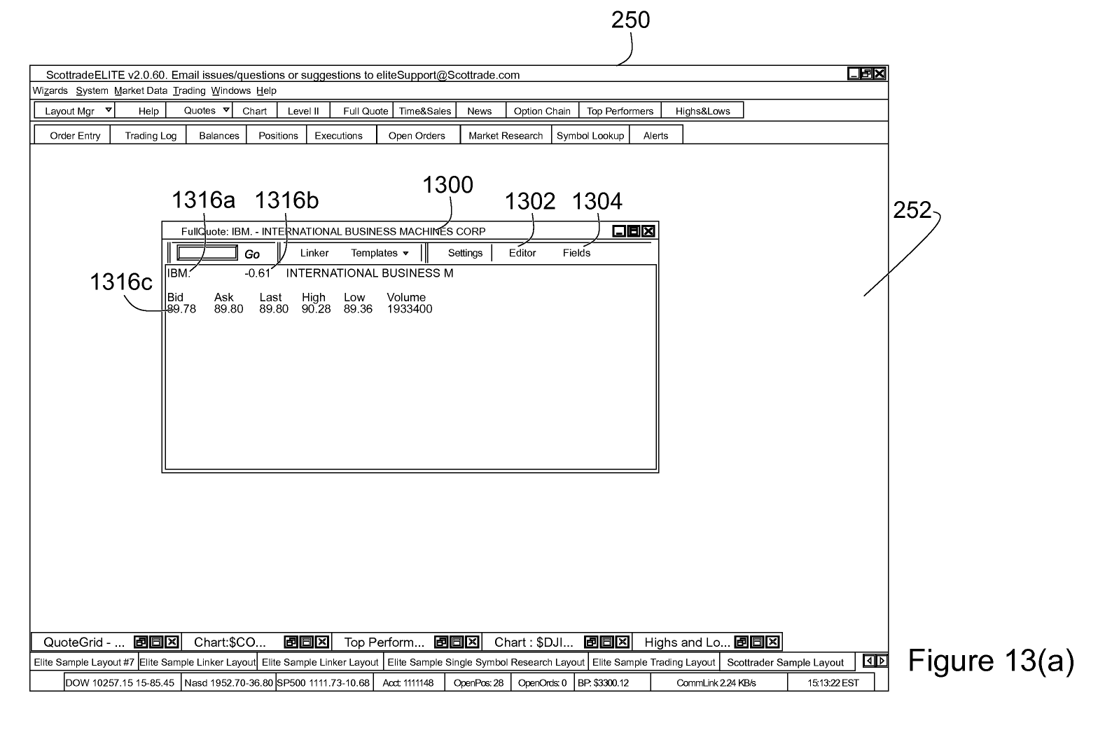

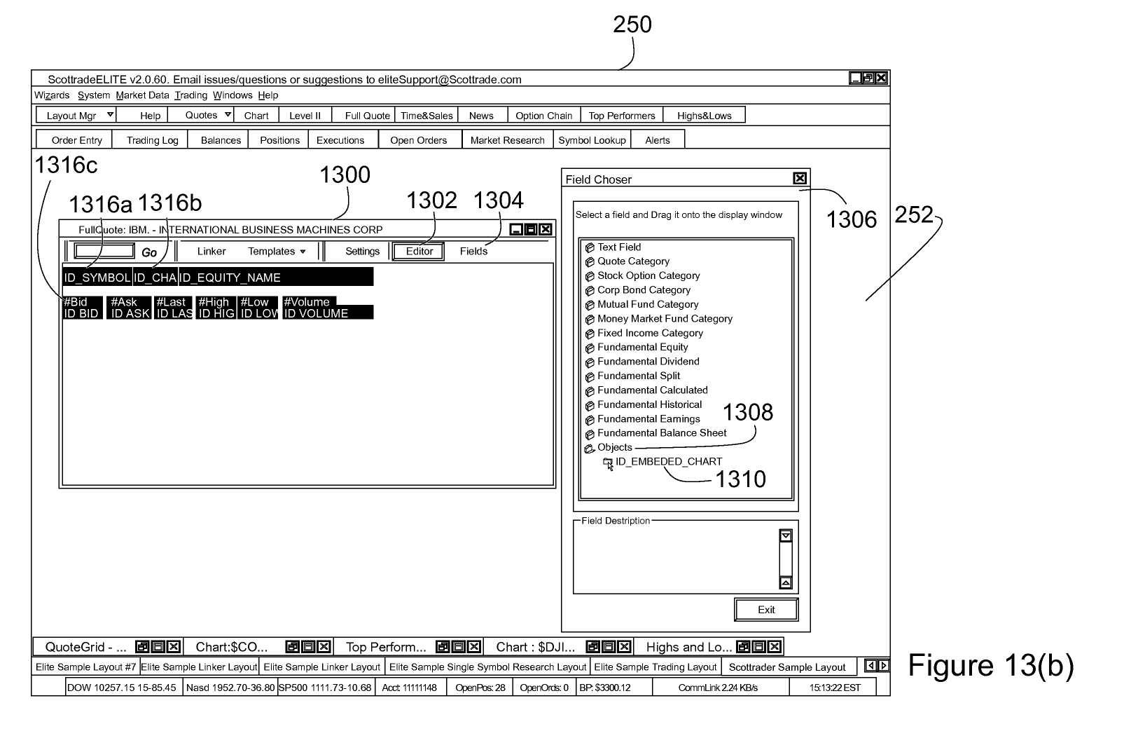

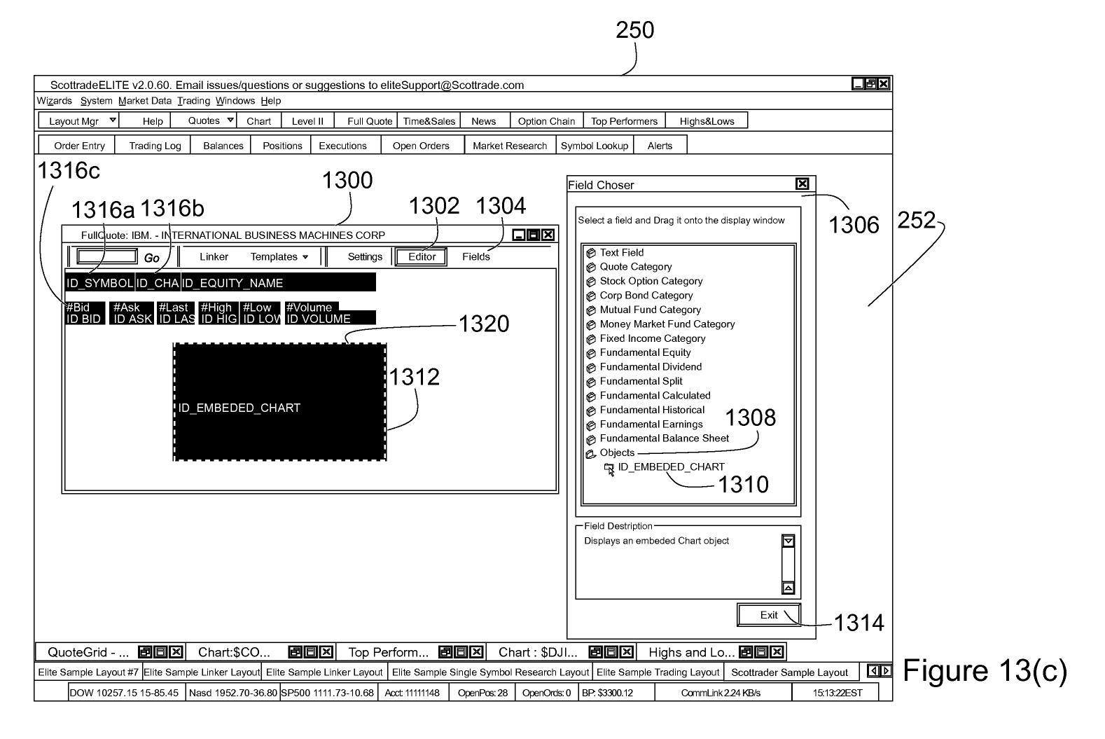

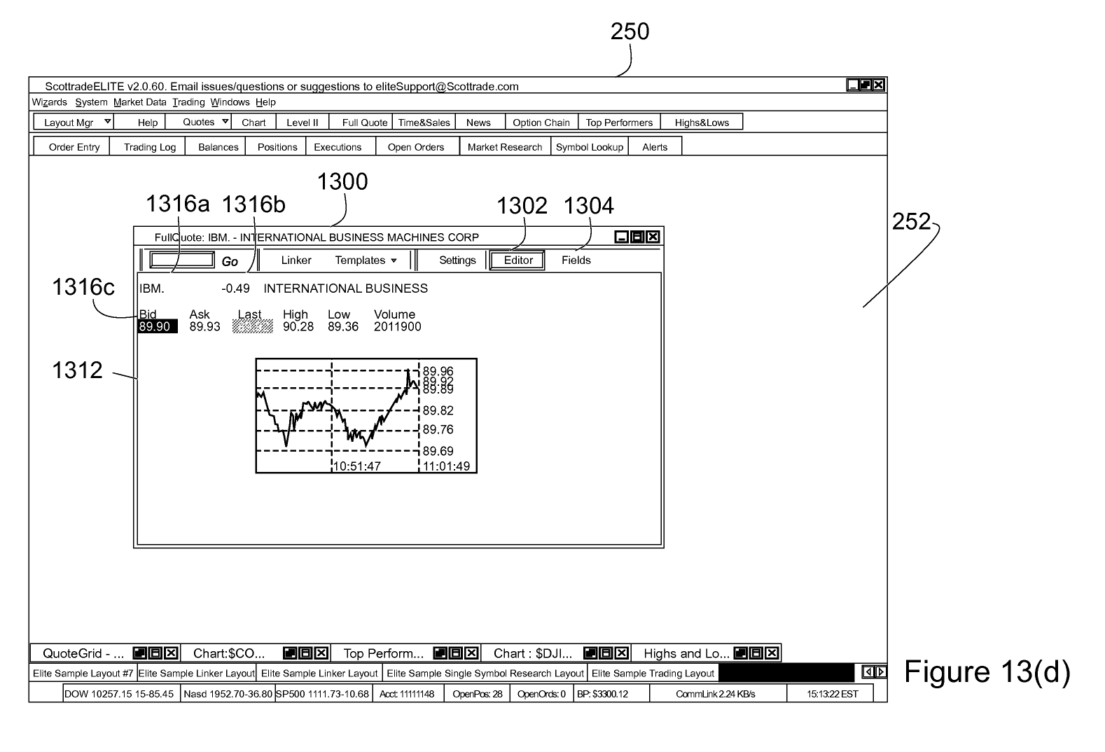

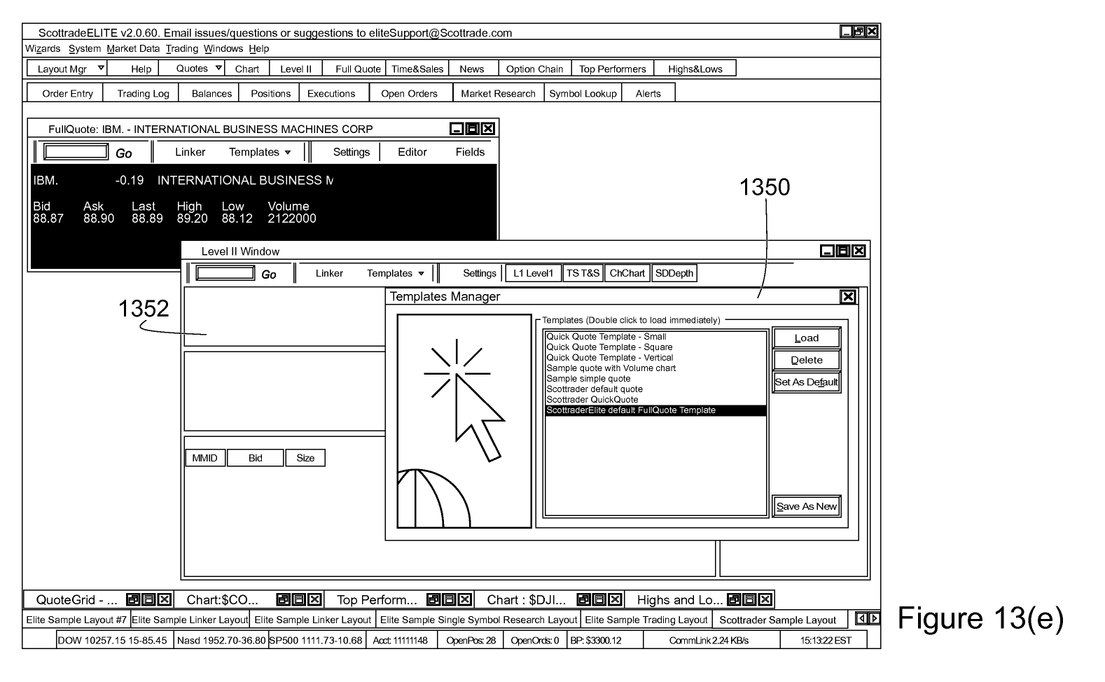

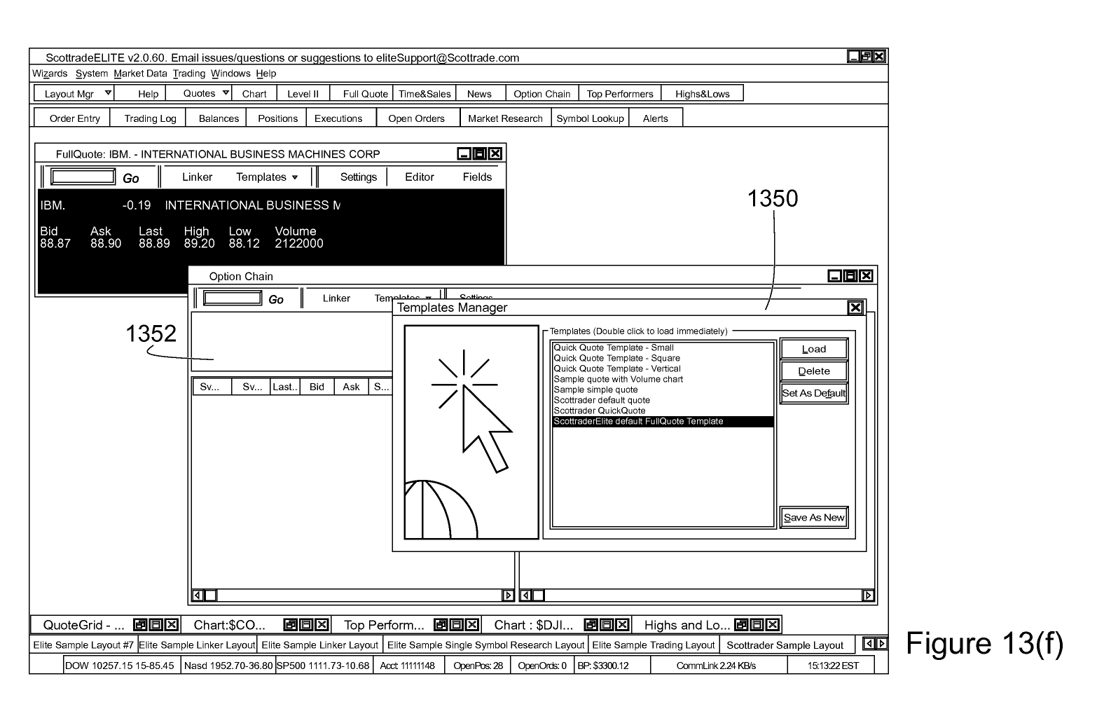

Yet another unique aspect of the preferred embodiment of the present invention relates to the ability of the user to embed charts from a chart window into other user interface windows, as shown in FIGS. 13(a)-(d). FIG. 13(a) depicts a full quote window 1300. A full quote window provides detailed quote data for a single financial instrument in a plurality of fields 1316a (for the symbol of the financial instrument), 1316b, 1316c, . . . A toolbar in the window 1300 provides the user with a button 1302 selectable by the user to transform the full quote window such that each field 1316a, 1316b, . . . is identified by a name rather than its actual data (as shown in window 1300 of FIG. 13(b)) and a button 1304 selectable by the user to edit what fields are shown in the full quote window. It should be noted that user selection of button 1304 can operate such that the view in window 1300 is transformed as if button 1302 had already been selected.

With reference to FIG. 13(b), upon selection of button 1304 by the user, pop-up window 1306 is displayed which lists a plurality of fields that can be displayed in the full quote window. By selecting a field and dragging the quote data identifier associated therewith into the full quote window 1300 to a location at which the user wishes to view that quote data, the user can add that field to the full quote display. As part of this control over the content of the full quote window, the user can embed a chart of quote data for financial instrument 1316a into the full quote window. First, the user selects the objects item 1308 listed in pop-up window 1306. Thereafter, once the chart identifier 1310 appears, the user can then drag the identifier 1310 to an appropriate location in window 1300 as an embedded chart 1312, as shown in FIG. 13(c). Chart 1312 can be resized as desired by the user by extending the border 1320 therearound as necessary. Upon user selection of the exit button 1314 in pop-up window 1306 and the button 1302 in full quote window 1300, the full quote window 1300 of FIG. 13(d) results, with embedded chart 1312 displayed at the location specified by the user.

Similarly, as shown in FIGS. 13(e) and (f), a user can easily import full quote templates into other windows such as a Level II window (FIG. 13(e)) or an option chain window (FIG. 13(f)) through a “templates manager” window 1350 accessed by a right click in an area 1352 of the Level II or option chain window, followed by a “templates” selection from a menu. Selection of the Full Quote template from the list of window 1350 will cause the full quote window layout to be loaded into area 1352.

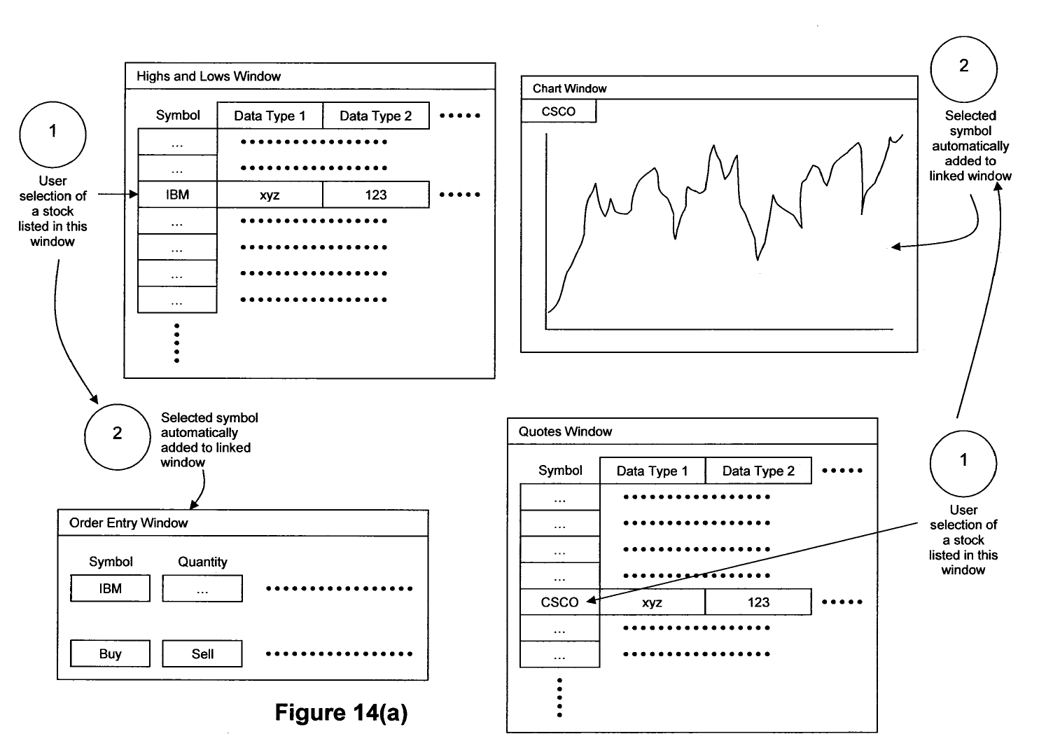

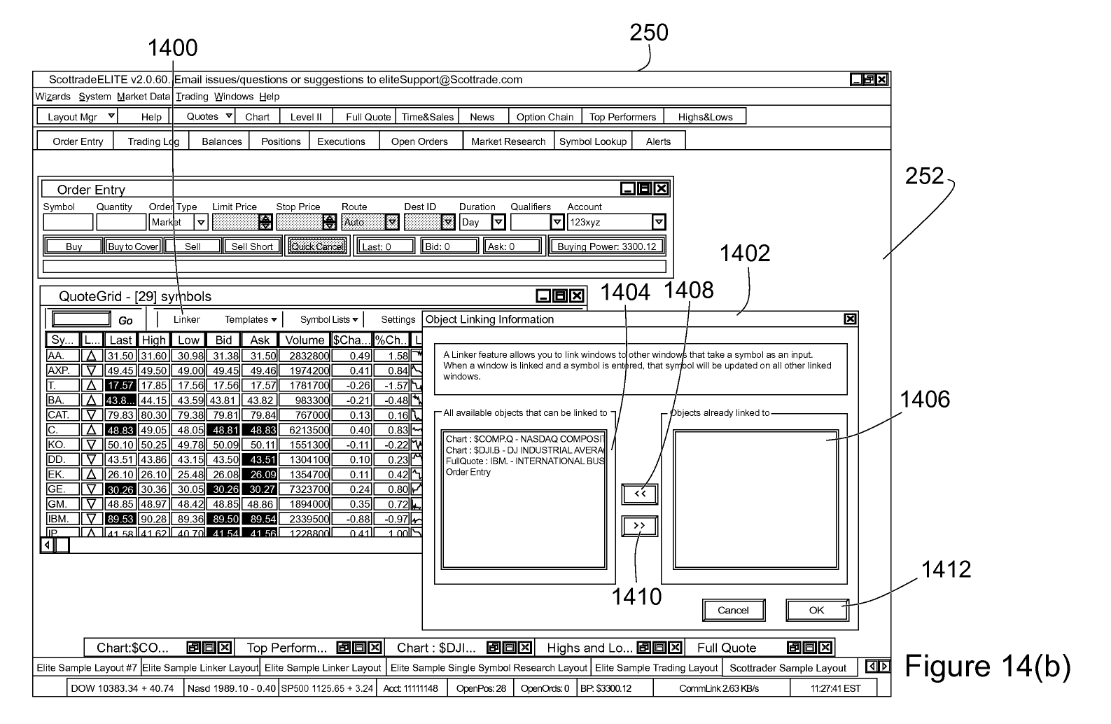

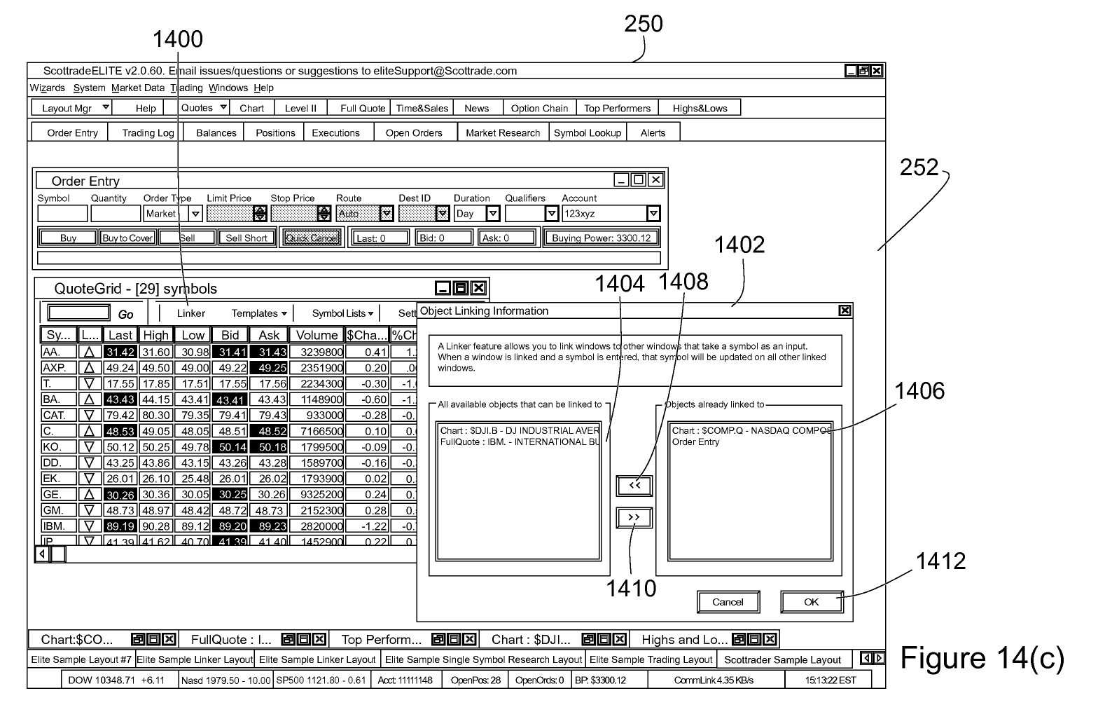

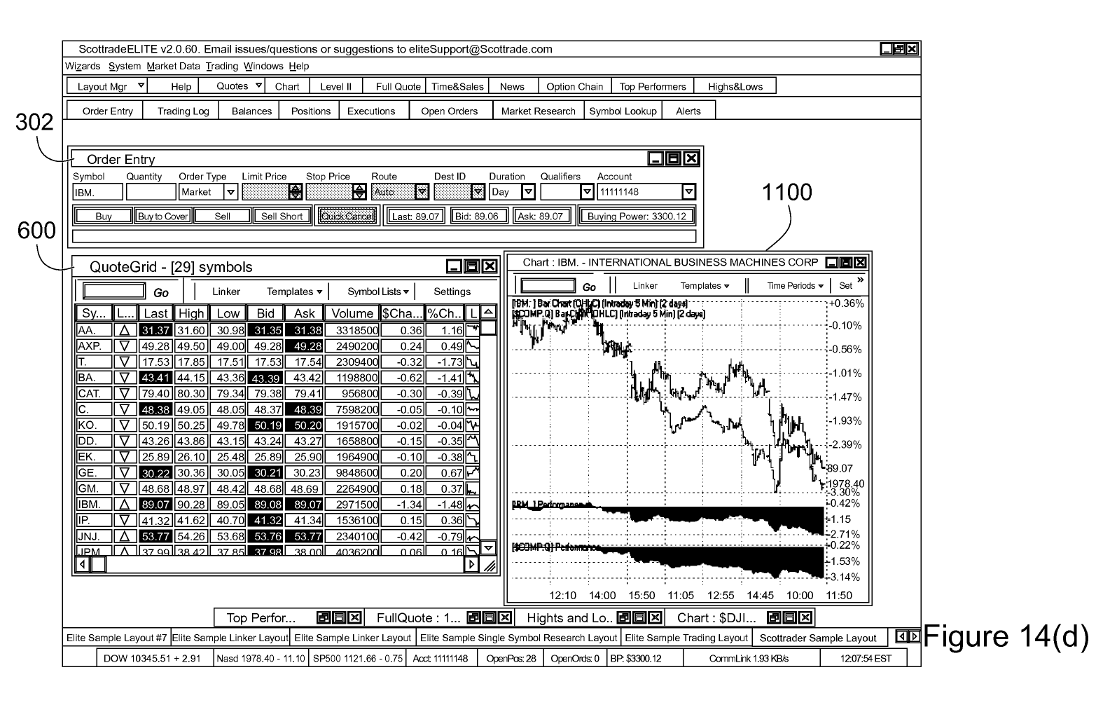

Yet another unique aspect of the preferred embodiment of the present invention relates to the ability of the user to link different interface windows together such that user action within one window will have an effect in another window, as shown in FIGS. 14(a) and (b). FIG. 14(a) illustrates the basic concept of this aspect of the preferred embodiment. In FIG. 14(a), the highs and lows window is linked with the order entry window and the chart window is linked with the quotes window. Through this linking, a user action within one window affecting a financial instrument will cause data related to that financial instrument to be added to the windows with which that window is linked. Thus, if a user were to click on the IBM stock listed in the highs and lows window, then an IBM identifier such as its symbol would be automatically loaded into the symbol field of the order entry window, as shown in FIG. 14(a). Similarly, if a user were to click on a listing for CSCO stock in the quotes window, then a chart for CSCO stock would be automatically added to the chart window. While the example of FIG. 14(a) depicts two sets of two linked windows, more than two windows can be commonly linked in the practice of this feature of the preferred embodiment.

The user action that is effective to invoke the linking functions is preferably a single click on some portion of the linked window that is applicable to a particular financial instrument. However, it should be understood that this aspect of the preferred embodiment may be modified such that a double click or right click is necessary to invoke the linking. Further still, the effective area which may be clicked to invoke the linking may also be modified, such as by reducing it to require the user to click on the actual identifier for the financial instrument rather than, in the example of a quote window or a highs and lows window, on any portion of the row associated with the financial instrument.

FIGS. 14(b)-(d) illustrate how the user can create links between user interface windows. A “linker” button 1400 is preferably provided in each user interface window other than the order entry window. However, it should be understood that the order entry window may also incorporate a “linker” button 1400. Upon user selection of a “linker” button 1400 in a user interface window, linking management pop-up window 1402 preferably is displayed. Through the linking management window 1402, the user can control the linking properties of the window in which the button 1400 was selected (the “linker” window).

Linking management window 1402 provides a list 1404 of eligible interface windows to which the linker window can be linked (the “linkee” windows). The eligible linkee windows are preferably any open interface window to which the user can input a financial instrument identifier such as a symbol. However, it should be noted that the list may also include any user interface window to which the user can input a symbol, whether or not that window is open when the linker button 1400 was selected. Windows are preferably identified on list 1404 by their name and pertinent data about their content (such as the number or name(s) of the financial instrument(s) included therein). As shown in FIG. 14(c), once the user selects an eligible linkee window from list 1404 and thereafter selects button 1410, the selected window from list 1404 will be added to list 1406, which identifies each linkee window for the linker window. Button 1408 can be used to move window(s) from list 1406 back to list 1404 (delinking). User selection of the OK button 1412 is effective to complete the linking operation. Thus, in the example of FIG. 14(c), it can be seen that the user has made the chart window 1100 and the order entry window 302 the linkee windows for the quote window 600, which is the linker window. Accordingly, if a user were to select the IBM symbol listed in the quote window 600, then data related to the IBM symbol would be added to both the order entry window 302 and the chart window 1100, as shown in FIG. 14(d).

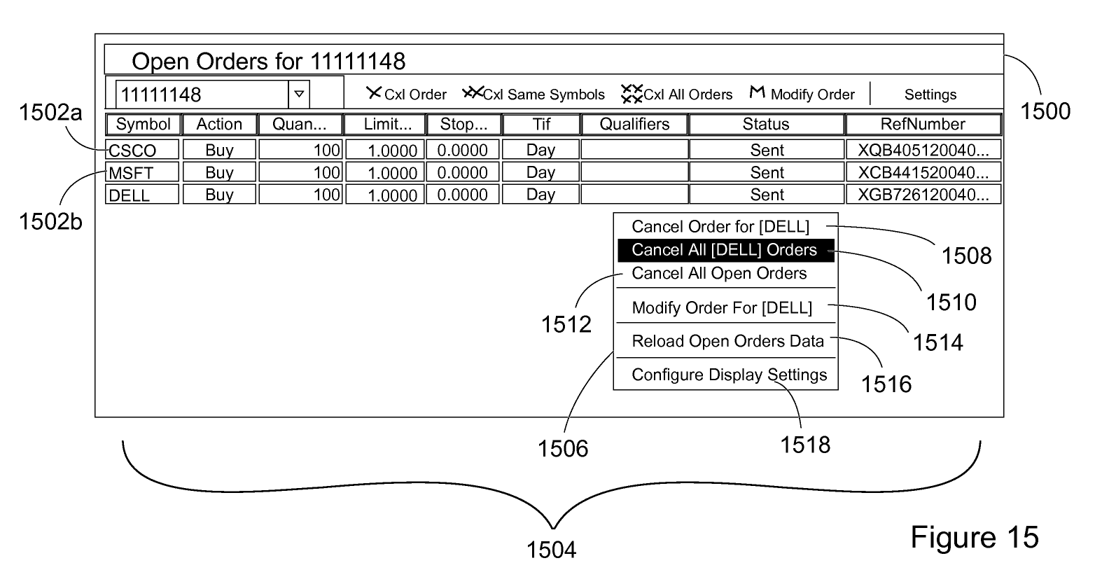

Yet another unique aspect of the preferred embodiment of the present invention allows a user action within an open orders window to open a menu providing the user with a plurality of options that affect the open orders listed in the open orders window, as shown in FIG. 15. The open orders window 1500 of FIG. 15 lists a plurality of rows 1502a, 1502b, . . . that each identify an open order for the user's account. Columns 1504 identify pertinent data about such open orders such as the financial instrument to which the open order pertains, a type for the open order (e.g., buy, sell, buy to cover, sell short, etc.), a quantity for the open order (e.g., the number of shares), and the like.

To provide the user with flexibility and efficiency in managing the open orders, the preferred embodiment preferably allows the user to perform a user action with an input device, such as a right click with a mouse, in an area of the open orders window to call up a menu 1506 that presents the user with a plurality of options for managing the open orders listed in the open orders window. Menu 1506 is preferably displayed within the open orders window 1500. The content of the menu 1506 will depend upon where the user placed the cursor at the time of the right click. Upon user selection within menu 1506, the program carries out the option so selected by the user. It is worth noting that user actions other than a right click can be used to call up menu 1506. For example, a double click of the left mouse button while the mouse cursor is located within the open orders window can be used as the user action that calls up the menu 1506. Further still, an input device other than a mouse can be used in the practice of this feature of the invention, such as an input device commonly associated with laptop computers (e.g., a roller ball and its associated click buttons).

If, at the time of the right click, the cursor was located on an area of the open orders window corresponding to a particular open order, the menu 1506 of FIG. 15 is preferably presented to the user. Menu 1506 provides the user with an option 1508 to cancel the particular open order listed in the row corresponding to the location of the right click, an option 1510 to cancel all open orders for the particular financial instrument identified in the row corresponding to the location of the right click, an option 1512 to cancel all open orders listed in the open orders window, an option 1514 to initiate a modification of the particular open order in the row corresponding to the location of the right click, an option 1516 to reload the data shown in the open orders window, and an option 1518 to configure the display settings of the open orders window. If, at the time of the right click the cursor was located on an area of the open orders window that did not correspond to a particular open order, then the resulting menu 1506 preferably would not include options 1508, 1510, and 1514.

While the present invention has been described above in relation to its preferred embodiment, various modifications may be made thereto that still fall within the invention's scope, as would be recognized by those of ordinary skill in the art. Such modifications to the invention will be recognizable upon review of the teachings herein. As such, the full scope of the present invention is to be defined solely by the appended claims and their legal equivalents.

What is claimed is:

1. A method of controlling the content of a chart window displayed to a user who is logged into a financial instrument trading account, said account being accessible through an on-line portal hosted by a services provider, the chart window depicting chart data relating to one or more financial instrument, the method comprising:
providing a chart window for display to the user, the chart window depicting data relating to at least one financial instrument, the chart window including a field through which the user can enter a plurality of modification instructions that are operative to modify the data depicted in the chart window;
simultaneously receiving a plurality of modification instructions from the user through the chart window field; and
modifying the chart window in accordance with the modification instructions.

2. The method of claim 1 wherein each modification instruction comprises a pair that includes a tag and an identifier for a financial instrument, the tag being indicative of how to modify the chart window.
